(19) United States
(12) Patent Application Publication
(10) Pub. No.: US 2026/0236101 A1
(43) Pub. Date: Aug. 13, 2026

(54) Haptic and Audio Effect of a Coil Actuator

(71) Applicant: Cirque Corporation, Sandy, UT (US)

(72) Inventors: John Aaron Zarraga, San Francisco, CA (US); Tomer Moscovich, San Francisco, CA (US)

(73) Assignee: Cirque Corporation, Sandy, UT (US)

(21) Appl. No.: 19/463,621

(22) Filed: Jan. 29, 2026

Related U.S. Application Data
(60) Provisional application No. 63/757,690, filed on Feb. 12, 2025.

(51) Int. Cl. G06F 3/01; G06F 3/044; H04R 1/02; H04R 3/02; H04R 9/06

(52) U.S. Cl. CPC G06F 3/016; G06F 3/0445; G06F 3/0446; H04R 1/028; H04R 3/02; H04R 9/06; H04R 2400/03

(57) ABSTRACT

A capacitance module may include a stack of layers, a set of capacitance electrodes disposed on a surface of the stack, a first actuator, including an inductance coil disposed on at least one surface of the stack and a magnetic field source positioned to at least partially overlap with the inductance coil, a processor in communication with the set of capacitance electrodes and the first actuator, and memory in communication with the processor. The memory may contain programmed instructions that cause the processor, when executed, to generate a composite drive signal having a haptic component and an audio component and drive the first actuator with the composite drive signal. The haptic component may have a lower center frequency than the audio component.

### CROSS REFERENCE TO RELATED APPLICATIONS

This application claims priority to U.S. Provisional Application No. 63/757,690 filed on February 12, 2025 and titled “System and Method for Outputting Audio and Haptic Feedback at a Human-Computer Interface.” U.S. Provisional Application No. 63/757,690 is hereby incorporated by reference in its entirety.

### FIELD OF THE DISCLOSURE

This disclosure relates generally to systems and methods for haptic devices. In particular, this disclosure relates to systems and methods for generating haptic and audio effects of capacitive devices.

### BACKGROUND

A capacitance sensor is often incorporated into touchpads of electronic devices such as a laptop to provide a mechanism for giving inputs to the device. Some touchpads may incorporate actuators which mechanically vibrate the touchpad to produce haptic feedback. Some actuators may be capable of producing vibrations with frequencies in the human-detectable range. Some devices may incorporate actuators which produce both haptic effects and audio effects.

An example of a device which produces haptic and sound effects is disclosed in U.S. Patent Publication No. 2012/0062491 issued to Philippe Coni, et al. This reference discloses techniques relating to an interaction device including a touch-sensitive surface and a chassis and making it possible to generate haptic, sound and visual interaction effects. The sound and haptic effects are generated by common structural and electronic means arranged so that the touch-sensitive surface and the chassis behave like a loudspeaker. The techniques also relate to generating interaction effects. The techniques also relate to a visualization device and apply to computers, televisions, telephones, and touch-sensitive tablets, for example. It preferably applies to visualization devices that have a screen with a large diagonal.

An example of a keyboard which generates haptic and sound effects using piezoelectric actuators is disclosed in U.S. Patent No. 11,579,695 issued to Priyank Gajiwala, et al. A haptic keyboard of an information handling system may comprise a coversheet to identify a key location, a support layer, a contact foil placed between the coversheet and support layer, and a controller operatively coupled to the contact foil. The controller may receive a haptic actuation indicator signal via a processor or via the contact foil, send a first haptic feedback control signal to a first piezoelectric element to cause the first piezoelectric element to generate haptic tactile movement feedback at the key location, and send a second haptic feedback control signal to the first or a second piezoelectric element to cause the second piezoelectric element to generate haptic sound feedback in response to the haptic actuation indicator signal.

Each of these references are herein incorporated by reference for all that they disclose.

### SUMMARY

In one embodiment, a capacitance module may include a stack of layers, a set of capacitance electrodes disposed on a surface of the stack, a first actuator, including an inductance coil disposed on at least one surface of the stack and a magnetic field source positioned to at least partially overlap with the inductance coil, a processor in communication with the set of capacitance electrodes and the first actuator, and memory in communication with the processor. The memory may contain programmed instructions that cause the processor, when executed, to generate a composite drive signal having a haptic component and an audio component, and drive the first actuator with the composite drive signal. The haptic component may have a lower center frequency than the audio component.

The haptic component may have a first frequency range, and the audio component may have a second frequency range. The first frequency range and the second frequency range may not overlap.

The first frequency range may be below approximately 300 Hz, and the second frequency range may be above approximately 1000 Hz.

The haptic component and the audio component may have frequency ranges which at least partially overlap.

The programmed instructions may further cause the processor, when executed, to detect a touch input based on capacitance measurement from the set of capacitance electrodes, and add the haptic component to the composite drive signal in response to detecting the touch input.

The programmed instructions may further cause the processor, when executed, to attenuate the audio component from the composite drive signal in response to detecting the touch input.

The programmed instructions may further cause the processor, when executed, to detect a touch release based on capacitance measurements from the set of capacitance electrodes, and add the audio component to the composite drive signal in response to detecting the touch release.

The programmed instructions may further cause the processor, when executed, to attenuate the haptic component from the composite drive signal in response to detecting the touch release.

The first actuator may be configured to provide a substantially consistent mechanical response over a frequency range from approximately 5 Hz to approximately 20,000 Hz.

The programmed instructions may further cause the processor, when executed, to receive an external audio signal, and generate at least one of the haptic component or the audio component based on the external audio signal such that the composite drive signal supplements the external audio signal.

The haptic component may be generated based on a low-frequency portion of the external audio signal.

The composite drive signal may be formed by superposition of the haptic component and the audio component.

The composite drive signal may be formed be formed by either haptic component amplitude modulated by the audio component or vice versa.

The capacitance module may further include a second actuator disposed on an opposite side of the stack from the first actuator, where the programmed instructions further cause the processor, when executed, to generate a stereo audio output by driving the first actuator with a first audio component and the second actuator with a second audio component different from the first audio component.

The haptic component and the audio component may be assigned relative priorities, where an amplitude of at least one of the haptic component or the audio component is attenuated based on the assigned priorities.

In another embodiment, a computer-program product for driving a coil actuator of a capacitance module may include a non-transitory computer-readable medium storing instructions executable by a processor to generate a composite drive signal having a haptic component and an audio component, and drive the coil actuator with the composite drive signal, where the haptic component has a lower center frequency than the audio component.

The medium may store further instructions executable by a processor to detect a touch input based on capacitance measurements from a set of capacitance electrodes on the capacitance module, add the haptic component to the composite drive signal in response to detecting the touch input, and attenuate the audio component from the composite drive signal in response to detecting the touch input.

The medium may store further instructions executable by a processor to detect a touch release based on capacitance measurements from a set of capacitance electrodes of the capacitance module, add the audio component to the composite drive signal in response to detecting the touch release, and attenuate the haptic component from the composite drive signal in response to detecting the touch release.

The medium may store further instructions executable by a processor to receive an external audio signal, and generate at least one of the haptic component or the audio component based on the external audio signal such that the composite drive signal supplements the external audio signal.

The medium may store further instructions executable by a processor to assign a first priority value to the audio component, and assign a second priority value to the haptic component, where the relative amplitudes of the haptic component and the audio component are based, at least in part, on the first priority value and the second priority value.

### BRIEF DESCRIPTION OF THE DRAWINGS

FIG. 1 depicts an example of an electronic device in accordance with the disclosure.

FIG. 2 depicts an example of a substrate with a first set of electrodes and a second set of electrodes in accordance with the disclosure.

FIG. 3 depicts an example of a touch pad in accordance with the disclosure.

FIG. 4 depicts an example of a touch screen in accordance with the disclosure.

FIG. 5 depicts an example of an input surface in accordance with the disclosure.

FIG. 6 depicts an example of an input surface in accordance with the disclosure.

FIG. 7 depicts an example of an arrangement of pressure sensors in accordance with the disclosure.

FIG. 8 depicts an example of an arrangement of pressure sensors in accordance with the disclosure.

FIG. 9 depicts an example of an arrangement of pressure sensors in accordance with the disclosure.

FIG. 10 depicts an example of an arrangement of pressure sensors in accordance with the disclosure.

FIG. 11 depicts an example of a capacitance module in accordance with the disclosure.

FIG. 12 depicts an example of a capacitance module in accordance with the disclosure.

FIG. 13 depicts an example of an acceleration frequency graph in accordance with the disclosure.

FIG. 14 depicts an example of a signal graph in accordance with the disclosure.

FIG. 15 depicts an example of a signal graph in accordance with the disclosure.

FIG. 16 depicts an example of a capacitance module in accordance with the disclosure.

FIG. 17 depicts an example of a capacitance module in accordance with the disclosure.

FIG. 18 depicts an example of a capacitance module in accordance with the disclosure.

FIG. 19 depicts an example of a method of using a user input in accordance with the disclosure.

FIG. 20 depicts an example of a method of using a user input in accordance with the disclosure.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION OF THE INVENTION

This description provides examples, and is not intended to limit the scope, applicability, or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, it should be appreciated that the methods may be performed in an order different than that described, and that various steps may be added, omitted, or combined. Also, aspects and elements described with respect to certain embodiments may be combined in various other embodiments. It should also be appreciated that the following systems, methods, devices, and software may individually or collectively be components of a larger system, wherein other procedures may take precedence over or otherwise modify their application.

For purposes of this disclosure, the term “aligned” generally refers to being parallel, substantially parallel, or forming an angle of less than 35.0 degrees. For purposes of this disclosure, the term “transverse” generally refers to perpendicular, substantially perpendicular, or forming an angle between 55.0 and 125.0 degrees. For purposes of this disclosure, the term “length” generally refers to the longest dimension of an object. For purposes of this disclosure, the term “width” generally refers to the dimension of an object from side to side and may refer to measuring across an object perpendicular to the object’s length.

For purposes of this disclosure, the term “electrode” may generally refer to a portion of an electrical conductor intended to be used to make a measurement, and the terms “route” and “trace” generally refer to portions of an electrical conductor that are not intended to make a measurement. For purposes of this disclosure in reference to circuits, the term “line” generally refers to the combination of an electrode and a “route” or “trace” portions of the electrical conductor. For purposes of this disclosure, the term “Tx” generally refers to a transmit line, electrode, or portions thereof, and the term “Rx” generally refers to a sense line, electrode, or portions thereof.

For the purposes of this disclosure, the term “electronic device” may generally refer to devices that may be transported and include a battery and electronic components. Examples may include a laptop, a desktop, a mobile phone, an electronic tablet, a personal digital device, a watch, a gaming controller, a gaming wearable device, a wearable device, a measurement device, an automation device, a security device, a display, a computer mouse, a vehicle, an infotainment system, an audio system, a control panel, another type of device, an athletic tracking device, a tracking device, a card reader, a purchasing station, a kiosk, or combinations thereof.

It should be understood that use of the terms “capacitance module,” “touch pad” and “touch sensor” throughout this document may be used interchangeably with “capacitive touch sensor,” “capacitive sensor,” “capacitance sensor,” “capacitive touch and proximity sensor,” “proximity sensor,” “touch and proximity sensor,” “touch panel,” “trackpad,” “touch pad,” and “touch screen.” The capacitance module may be incorporated into an electronic device.

It should also be understood that, as used herein, the terms “vertical,” “horizontal,” “lateral,” “upper,” “lower,” “left,” “right,” “inner,” “outer,” etc., may refer to relative directions or positions of features in the disclosed devices and/or assemblies shown in the Figures. For example, “upper” or “uppermost” may refer to a feature positioned closer to the top of a page than another feature. These terms, however, should be construed broadly to include devices and/or assemblies having other orientations, such as inverted or inclined orientations where top/bottom, over/under, above/below, up/down, and left/right may be interchanged depending on the orientation.

In some cases, the capacitance module is located within a housing. The capacitance module may be underneath the housing and capable of detecting objects outside of the housing. In examples, where the capacitance module may detect changes in capacitance through a housing, the housing is a capacitance reference surface. For example, the capacitance module may be disclosed within a cavity formed by a keyboard housing of a computer, such as a laptop or other type of computing device, and the sensor may be disposed underneath a surface of the keyboard housing. In such an example, the keyboard housing adjacent to the capacitance module is the capacitance reference surface. In some examples, an opening may be formed in the housing, and an overlay may be positioned within the opening. In this example, the overlay is the capacitance reference surface. In such an example, the capacitance module may be positioned adjacent to a backside of the overlay, and the capacitance module may sense the presence of the object through the thickness of the overlay. For the purposes of this disclosure, the term “reference surface” may generally refer to a surface through which a pressure sensor, a capacitance sensor, or another type of sensor is positioned to sense a pressure, a presence, a position, a touch, a proximity, a capacitance, a magnetic property, an electric property, another type of property, or another characteristic, or combinations thereof that indicates an input. For example, the reference surface may be a housing, an overlay, or another type of surface through which the input is sensed. In some examples, the reference surface has no moving parts. In some examples, the reference surface may be made of any appropriate type of material, including, but not limited to, plastics, glass, a dielectric material, a metal, another type of material, or combinations thereof.

For the purposes of this disclosure, the term “display” may generally refer to a display or screen that is not depicted in the same area as the capacitive reference surface. In some cases, the display is incorporated into a laptop where a keyboard is located between the display and the capacitive reference surface. In some examples where the capacitive reference surface is incorporated into a laptop, the capacitive reference surface may be part of a touch pad. Pressure sensors may be integrated into the stack making up the capacitance module. However, in some cases, the pressure sensors may be located at another part of the laptop, such as under the keyboard housing, but outside of the area used to sense touch inputs, on the side of the laptop, above the keyboard, to the side of the keyboard, at another location on the laptop, or at another location. In examples where these principles are integrated into a laptop, the display may be pivotally connected to the keyboard housing. The display may be a digital screen, a touch screen, another type of screen, or combinations thereof. In some cases, the display is located on the same device as the capacitive reference surface, and in other examples, the display is located on another device that is different from the device on which the capacitive reference surface is located. For example, the display may be projected onto a different surface, such as a wall or projector screen. In some examples, the reference surface may be located on an input or gaming controller, and the display is located on a wearable device, such as a virtual reality or augmented reality screen. In some cases, the reference surface and the display are located on the same surface, but on separate locations on that surface. In other examples, the reference surface and the display may be integrated into the same device, but on different surfaces. In some cases, the reference surface and the display may be oriented at different angular orientations with respect to each other.

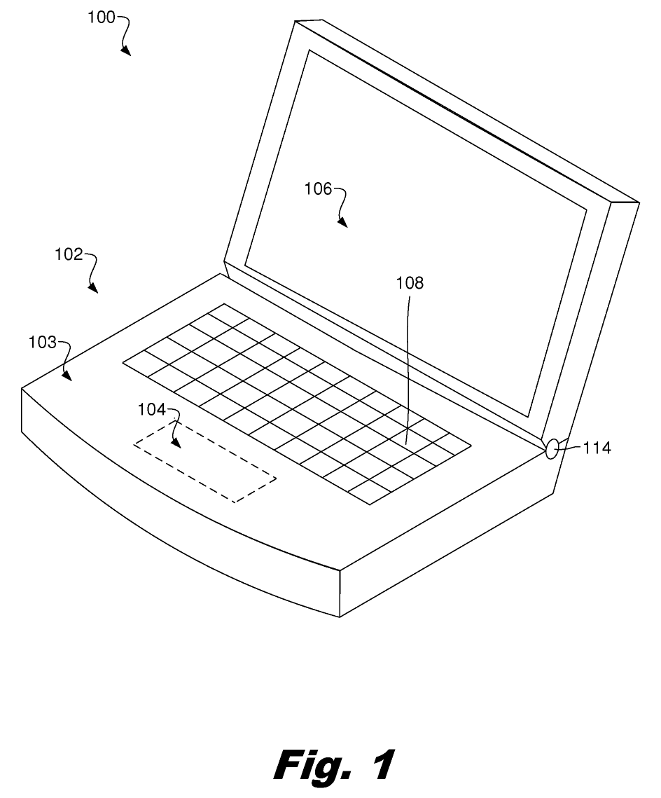

FIG. 1 depicts an example of an electronic device 100. In this example, the electronic device is a laptop. In the illustrated example, the electronic device 100 includes input components, such as a keyboard 102 and a capacitive module, such as a touch pad 104, that are incorporated into a housing 103. The electronic device 100 also includes a display 106. A program operated by the electronic device 100 may be depicted in the display 106 and controlled by a sequence of instructions that are provided by the user through the keyboard 102 and/or through the touch pad 104. An internal battery (not shown) may be used to power the operations of the electronic device 100.

The keyboard 102 includes an arrangement of keys 108 that may be individually selected when a user presses on a key with a sufficient force to cause the key 108 to be depressed towards a switch located underneath the keyboard 102. In response to selecting a key 108, a program may receive instructions on how to operate, such as a word processing program determining which types of words to process. A user may use the touch pad 104 to give different types of instructions to the programs operating on the computing device 100. For example, a cursor depicted in the display 106 may be controlled through the touch pad 104. A user may control the location of the cursor by sliding his or her hand along the surface of the touch pad 104. In some cases, the user may move the cursor to be located at or near an object in the computing device’s display and give a command through the touch pad 104 to select that object. For example, the user may provide instructions to select the object by tapping the surface of the touch pad 104 one or more times.

The touch pad 104 is a capacitance module that includes a stack of layers disposed underneath the keyboard housing, underneath an overlay that is fitted into an opening of the keyboard housing, or underneath another capacitive reference surface. In some examples, the capacitance module is located in an area of the keyboard’s surface where the user’s palms may rest while typing. The capacitance module may include a substrate, such as a printed circuit board or another type of substrate. One of the layers of the capacitance module may include a sensor layer that includes a first set of electrodes oriented in a first direction and a second layer of electrodes oriented in a second direction that is transverse the first direction. These electrodes may be spaced apart and/or electrically isolated from each other. The electrical isolation may be accomplished by deposited at least a portion of the electrodes on different sides of the same substrate or providing dedicated substrates for each set of electrodes. Capacitance may be measured at the overlapping intersections between the different sets of electrodes. However, as an object with a different dielectric value than the surrounding air (e.g., finger, stylus, etc.) approach the intersections between the electrodes, the capacitance between the electrodes may change. This change in capacitance and the associated location of the object in relation to the capacitance module may be calculated to determine where the user is touching or hovering the object within the detection range of the capacitance module. In some examples, the first set of electrodes and the second set of electrodes are equidistantly spaced with respect to each other. Thus, in these examples, the sensitivity of the capacitance module is the same in both directions. However, in other examples, the distance between the electrodes may be non-uniformly spaced to provide greater sensitivity for movements in certain directions.

In some cases, the display 106 is mechanically separate and movable with respect to the keyboard with a connection mechanism 114. In these examples, the display 106 and keyboard 102 may be connected and movable with respect to one another. The display 106 may be movable within a range of 0 degrees to 180 degrees or more with respect to the keyboard 102. In some examples, the display 106 may fold over onto the upper surface of the keyboard 102 when in a closed position, and the display 106 may be folded away from the keyboard 102 when the display 106 is in an operating position. In some examples, the display 106 may be orientable with respect to the keyboard 102 at an angle between 35 to 135 degrees when in use by the user. However, in these examples, the display 106 may be positionable at any angle desired by the user.

In some examples, the display 106 may be a non-touch sensitive display. However, in other examples at least a portion of the display 106 is touch sensitive. In these examples, the touch sensitive display may also include a capacitance module that is located behind an outside surface of the display 106. As a user’s finger or other object approaches the touch sensitive screen, the capacitance module may detect a change in capacitance as an input from the user.

While the example of FIG. 1 depicts an example of the electronic device being a laptop, the capacitance sensor and touch surface may be incorporated into any appropriate device. A non-exhaustive list of devices includes, but is not limited to, a desktop, a display, a screen, a kiosk, a computing device, an electronic tablet, a smart phone, a location sensor, a card reading sensor, another type of electronic device, another type of device, or combinations thereof.

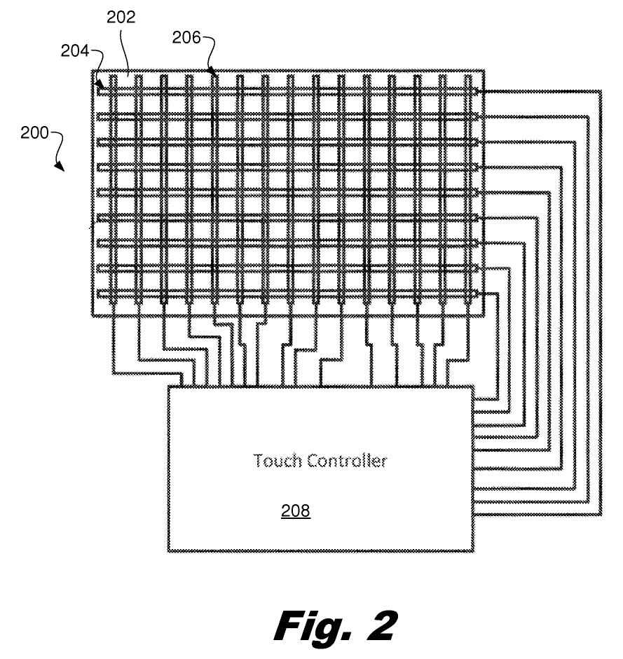

FIG. 2 depicts an example of a portion of a capacitance module 200. In this example, the capacitance module 200 may include a substrate 202, first set 204 of electrodes, and a second set 206 of electrodes. The first and second sets 204, 206 of electrodes may be oriented to be transverse to each other. Further, the first and second sets 204, 206 of electrodes may be electrically isolated from one another so that the electrodes do not short to each other. However, where electrodes from the first set 204 overlap with electrodes from the second set 206, capacitance may be measured. The capacitance module 200 may include one or more electrodes in the first set 204 or the second set 206. Such a substrate 202 and electrode sets may be incorporated into a touch screen, a touch pad, a location sensor, a gaming controller, a button, and/or detection circuitry.

In some examples, the capacitance module 200 is a mutual capacitance sensing device. In such an example, the substrate 202 has a set 204 of row electrodes and a set 206 of column electrodes that define the touch/proximity-sensitive area of the component. In some cases, the component is configured as a rectangular grid of an appropriate number of electrodes (e.g., 8-by-6, 16-by-12, 9-by-15, or the like).

As shown in FIG. 2, the capacitance module 208 includes a capacitance controller 208. The capacitance controller 208 may include at least one of a central processing unit (CPU), a digital signal processor (DSP), an analog front end (AFE) including amplifiers, a peripheral interface controller (PIC), another type of microprocessor, and/or combinations thereof, and may be implemented as an integrated circuit, a field programmable gate array (FPGA), an application specific integrated circuit (ASIC), a combination of logic gate circuitry, other types of digital or analog electrical design components, or combinations thereof, with appropriate circuitry, hardware, firmware, and/or software to choose from available modes of operation.

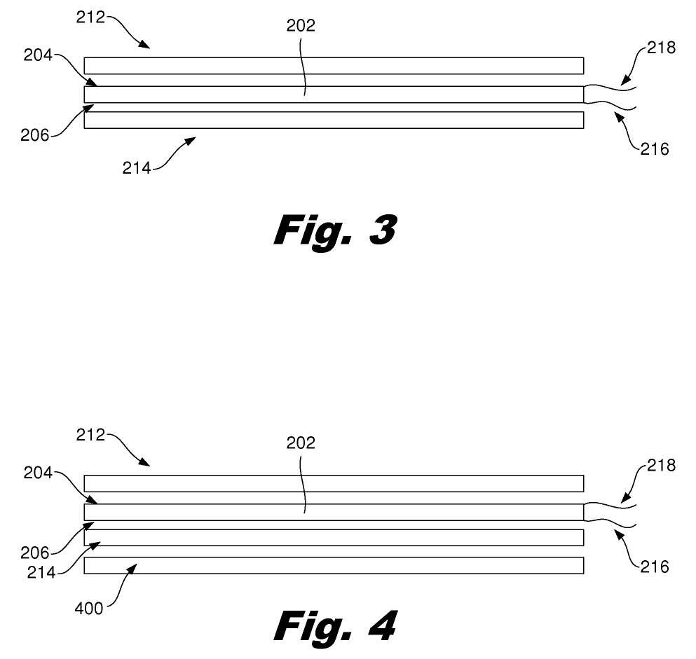

In some cases, the capacitance controller 208 includes at least one multiplexing circuit to alternate which of the sets 204, 206 of electrodes are operating as drive electrodes and sense electrodes. The driving electrodes may be driven one at a time in sequence, or randomly, or drive multiple electrodes at the same time in encoded patterns. Other configurations are possible such as a self-capacitance mode where the electrodes are driven and sensed simultaneously. Electrodes may also be arranged in non-rectangular arrays, such as radial patterns, linear strings, or the like. A shield layer (see FIG. 3) may be provided beneath the electrodes to reduce noise or other interference. The shield may extend beyond the grid of electrodes. Other configurations are also possible.

In some cases, no fixed reference point is used for measurements. The touch controller 208 may generate signals that are sent directly to the first or second sets 204, 206 of electrodes in various patterns.

In some cases, the component does not depend upon an absolute capacitive measurement to determine the location of a finger (or stylus, pointer, or other object) on a surface of the capacitance module 200. The capacitance module 200 may measure an imbalance in electrical charge to the electrode functioning as a sense electrode which may, in some examples, be any of the electrodes designated in either set 204, 206 or, in other examples, with dedicated-sense electrodes. When no pointing object is on or near the capacitance module 200, the capacitance controller 208 may be in a balanced state, and there is no signal on the sense electrode. When a finger or other pointing object creates imbalance because of capacitive coupling, a change in capacitance may occur at the intersections between the sets of electrodes 204, 206 that make up the touch/proximity sensitive area. In some cases, the change in capacitance is measured. However, in alternative example, the absolute capacitance value may be measured.

While this example has been described with the capacitance module 200 having the flexibility of the switching the sets 204, 206 of electrodes between sense and transmit electrodes, in other examples, each set of electrodes is dedicated to either a transmit function or a sense function.

FIG. 3 depicts an example of a substrate 202 with a first set 204 of electrodes and a second set 206 of electrodes deposited on the substrate 202 that is incorporated into a capacitance module. The first set 204 of electrodes and the second set 206 of electrodes may be spaced apart from each other and electrically isolated from each other. In the example depicted in FIG. 3, the first set 204 of electrodes is deposited on a first side of the substrate 202, and the second set 206 of electrodes is deposited on the second side of the substrate 202, where the second side is opposite the first side and spaced apart by the thickness of the substrate 202. The substrate may be made of an electrically insulating material thereby preventing the first and second sets 204, 206 of electrodes from shorting to each other. As depicted in FIG. 2, the first set 204 of electrodes and the second set 206 of electrodes may be oriented transversely to one another. Capacitance measurements may be taken where the intersections with the electrodes from the first set 204 and the second set 206 overlap. In some examples, a voltage may be applied to the transmit electrodes and the voltage of a sense electrode that overlaps with the transmit electrode may be measured. The voltage from the sense electrode may be used to determine the capacitance at the intersection where the sense electrode overlaps with the transmit electrode.

In the example of FIG. 3 depicting a cross section of a capacitance module, the substrate 202 may be located between a capacitance reference surface 212 and a shield 214. The capacitance reference surface 212 may be a covering that is placed over the first side of the substrate 202 and that is at least partially transparent to electric fields. As a user’s finger or stylus approach the capacitance reference surface 212, the presence of the finger or the stylus may affect the electric fields on the substrate 202. With the presence of the finger or the stylus, the voltage measured from the sense electrode may be different than when the finger or the stylus are not present. As a result, the change in capacitance may be measured.

The shield 214 may be an electrically conductive layer that shields electric noise from the internal components of the electronic device. This shield may prevent influence on the electric fields on the substrate 202. In some cases, the shield is solid piece of material that is electrically conductive. In other cases, the shield has a substrate and an electrically conductive material disposed on at least one substrate. In yet other examples, the shield is layer in the touch pad that performs a function and also shields the electrodes from electrically interfering noise. For example, in some examples, a pixel layer in display applications may form images that are visible through the capacitance reference surface, but also shields the electrodes from the electrical noise.

The voltage applied to the transmit electrodes may be carried through an electrical connection 216 from the touch controller 208 to the appropriate set of electrodes. The voltage applied to the sense electrode through the electric fields generated from the transmit electrode may be detected through the electrical connection 218 from the sense electrodes to the touch controller 208.

While the example of FIG. 3 has been depicted as having both sets of electrodes deposited on a substrate, one set of electrodes deposited on a first side and a second set of electrodes deposited on a second side; in other examples, each set of electrodes may be deposited on its own dedicated substrate.

Further, while the examples above describe a touch pad with a first set of electrodes and a second set of electrodes; in some examples, the capacitance module has a single set of electrodes. In such an example, the electrodes of the sensor layer may function as both the transmit and the receive electrodes. In some cases, a voltage may be applied to an electrode for a duration of time, which changes the capacitance surrounding the electrode. At the conclusion of the duration of time, the application of the voltage is discontinued. Then a voltage may be measured from the same electrode to determine the capacitance. If there is no object (e.g., finger, stylus, etc.) on or in the proximity of the capacitance reference surface, then the measured voltage off of the electrode after the voltage is discontinued may be at a value that is consistent with a baseline capacitance. However, if an object is touching or in proximity to the capacitance reference surface, then the measured voltage may indicate a change in capacitance from the baseline capacitance.

In some examples, the capacitance module has a first set of electrodes and a second set of electrodes and is communication with a controller that is set up to run both mutual capacitance measurements (e.g., using both the first set and the second set of electrodes to take a capacitance measurement) or self-capacitance measurements (e.g., using just one set of electrodes to take a capacitance measurement).

FIG. 4 depicts an example of a capacitance module incorporated into a touch screen. In this example, the substrate 202, sets of electrodes 204, 206, and electrical connections 216, 218 may be similar to the arrangement described in conjunction with FIG. 3. In the example of FIG. 4, the shield 214 is located between the substrate 202 and a display layer 400. The display layer 400 may be a layer of pixels or diodes that illuminate to generate an image. The display layer may be a liquid crystal display, a light emitting diode display, an organic light emitting diode display, an electroluminescent display, a quantum dot light emitting diode display, an incandescent filaments display, a vacuum florescent display, a cathode gas display, another type of display, or combinations thereof. In this example, the shield 214, the substrate 202, and the capacitance reference surface 212 may all be at least partially optically transparent to allow the image depicted in the display layer to be visible to the user through the capacitance reference surface 212. Such a touch screen may be included in a monitor, a display assembly, a laptop, a mobile phone, a mobile device, an electronic tablet, a dashboard, a display panel, an infotainment device, another type of electronic device, or combinations thereof.

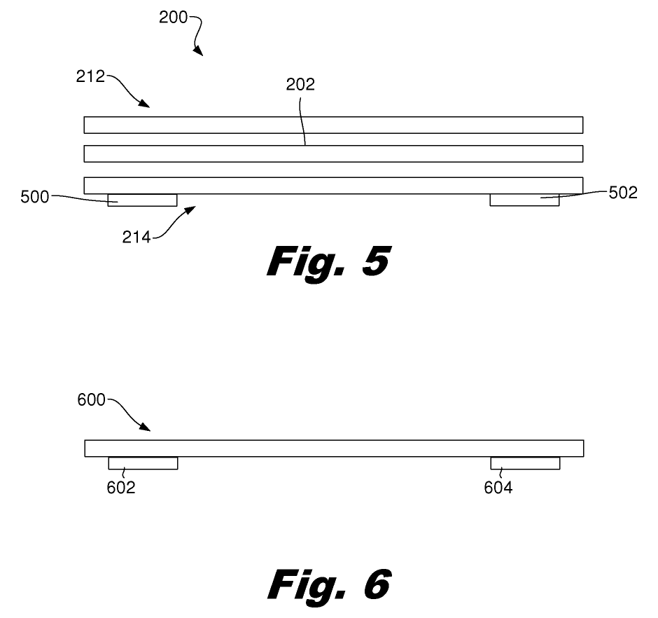

FIG. 5 depicts an example of a cross section of a capacitance module 200 where the substrate 202 may be located between a capacitance reference surface 212 and a shield 214. In this example, a first haptic actuator 500 and a second haptic actuator 502 are incorporated into the capacitance module 200. As depicted in this example, the haptic actuators 500, 502 may be disposed adjacent to an underside of the shield 214. But, in other examples, the haptic actuators may be positioned at any appropriate location, including, but not limited to, adjacent the underside of the capacitance reference surface 212, adjacent the underside of the shield, adjacent the underside of the substrate 202, on another surface, another location, or combinations thereof. In some cases, the parts of the haptic actuator may be spread across multiple layers of the module. In examples where the haptic actuators 500, 502 are positioned under the substrate 202.

In some examples, the haptic actuator may also be a pressure sensor. In such an example, pressure applied to the capacitance reference surface 212 may be transmitted through the capacitance reference surface 212 exerting a pressure on the substrate 202, which in turn applies a pressure to at least one of the haptic actuators 500, 502. In examples where the haptic actuators are positioned adjacent to the shield, the pressure applied to the input surface may be transmitted to the shield, which in turn applies the pressure to the haptic actuators. This pressure may be measured by the haptic actuators 500, 502 to determine the value of the pressure.

In the depicted example, the first haptic actuator 500 is spaced apart from the second haptic actuator 502 at a distance along a length, width, and/or another dimension of the capacitance reference surface 212, which may allow the first haptic actuator 500 and the second haptic actuator 502 to detect different levels of pressure depending on the location where the pressure input is made on the capacitance reference surface 212. In some cases, those haptic actuators that are closer to the location where the pressure input is made may detect a greater pressure force than the haptic actuator that is located farther away. The differing pressure values may help determine where the pressure input is made.

While this example has been describe with reference to the haptic actuators having the ability to measure pressure, in other examples, the haptic actuators are not capable of measuring pressure or may not be used to measure pressure. In some cases, the haptic actuators may be capable of measuring pressure, but the module may include at least one mechanism that may be used to measure pressure. In some cases, the module may include at least one dedicated pressure sensor in addition to the haptic actuator(s).

Any appropriate type of pressure sensor may be used in accordance with the principles described herein. For example, a non-exhaustive list of suitable pressure sensors includes, but is not limited to, piezoelectric sensors, magnostrictive sensors, potentiometric pressure sensors, inductive pressure sensors, capacitive pressure sensors, strain gauge pressure sensors, variable reluctance pressure sensors, other types of pressure sensors, or combinations thereof.

In some examples, the pressure sensor is a piezoelectric device that may be used as both a pressure sensor and as a haptic device. When the piezoelectric material is compressed due to the application of pressure through the capacitance reference surface, the piezoelectric material may produce an electric signal with may be detected by a controller. In some cases, the controller may produce an electric signal that is sent to the piezoelectric material to cause the piezoelectric material to expand, contract, and/or vibrate. The vibrations from the piezoelectric material may cause the capacitance reference surface to vibrate. This vibration may communicate a haptic signal to the user. However, in some examples, the pressure sensors are not configured to provide a haptic signal.

FIG. 6 depicts an example of a reference surface 600. In this example, a first haptic actuator 602 and a second haptic actuator 604 are located adjacent to the reference surface 600. In this example, the first haptic actuator 602 and the second haptic actuator 604 are not incorporated into a stack having a capacitance sensor.

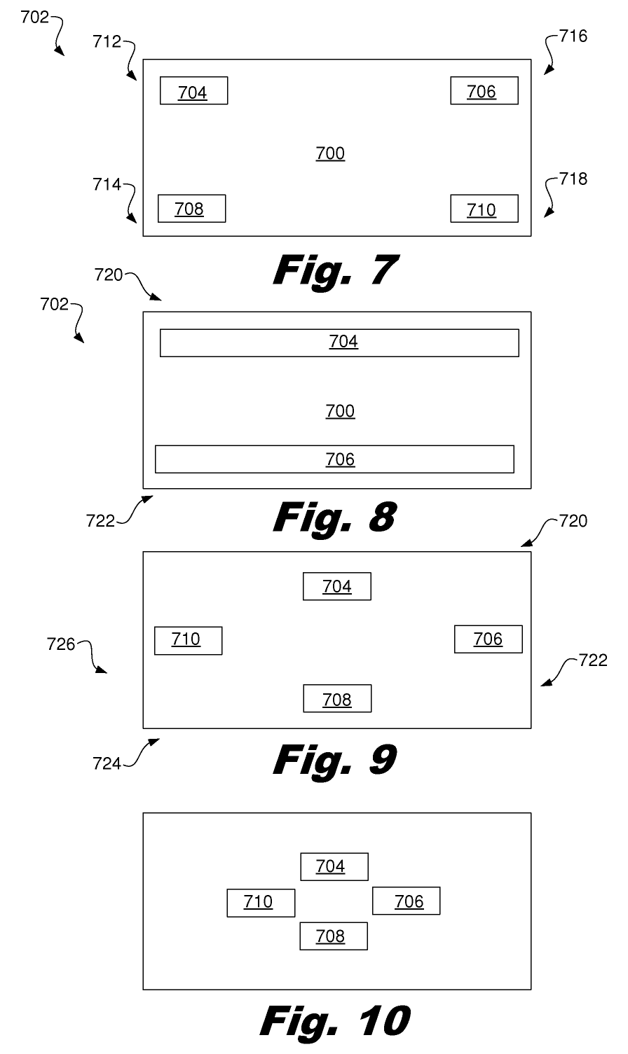

FIGS. 7-10 depict examples of haptic actuators depicted on an underside 700 of a reference surface 702. In the example of FIG. 7, the reference surface 702 has a rectangular shape and haptic actuators 704, 706, 708, 710 are positioned in each of the corners 712, 714, 716, 718. In the example of FIG. 8, just a first haptic actuator 704 is depicted on a first side 720, and a second haptic actuator 706 is depicted on a second side 722 of the input surface 702. In the example of FIG. 9, the haptic actuators 704, 706, 708, 710 are depicted in the center of the first side 720, the second side 722, the third side 724, and the fourth side 726. In the examples of FIG. 10, the haptic actuators 704, 706, 708, 710 are depicted towards the center of the input surface and away from the edges and corners of the input surface 702.

While the examples in FIGS. 7-10 are described with reference to a specific number of haptic actuators, any appropriate number of haptic actuators may be disposed adjacent to the input surface. For example, the number of haptic actuators may include one haptic actuator or multiple haptic actuators. While the examples depicted above are described with reference to specific patterns and locations for the haptic actuators, other arrangements are contemplated including, but not limited to, symmetric distribution of sensors, an asymmetric distribution of sensors, other distributions and patterns of sensors, or combinations thereof.

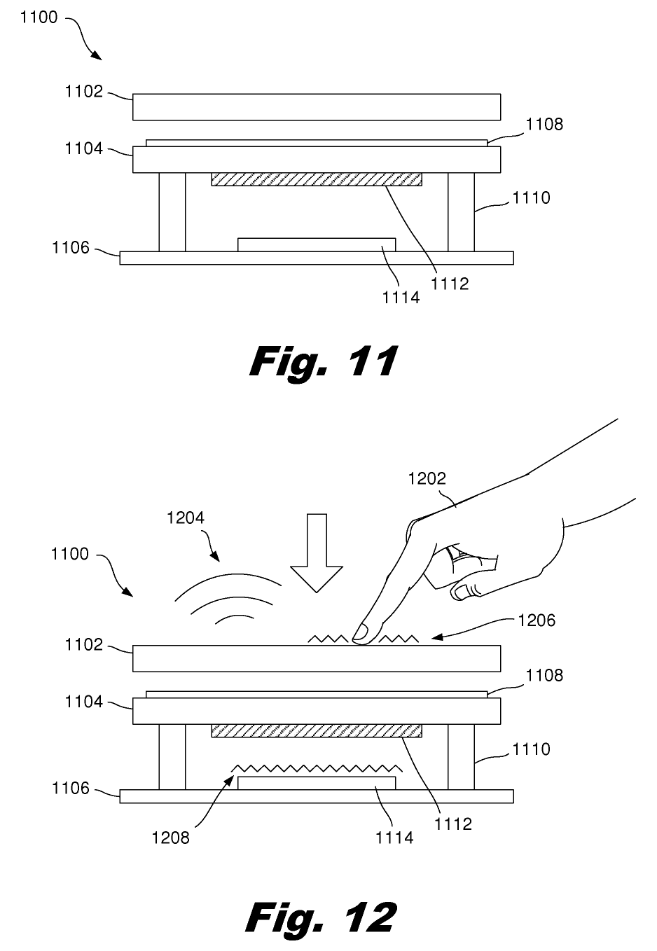

FIG. 11 depicts an example of a capacitance module 1100 in accordance with the disclosure. In this example, the capacitance module 1100 includes a capacitance reference surface 1102, a component layer 1104, and a baseplate 1106.

The capacitance reference surface 1102 may form an input surface through which capacitance measurements are taken. A user may interact with the capacitance module 1100 by touching the capacitance reference surface 1102 or by bringing a finger, stylus, or other input object into proximity with the reference surface. The presence, location, movement, and/or pressure of the input object may be detected based on changes in capacitance measured by the capacitance module. The capacitance reference surface 1102 may be made of a material partially transparent to electric fields. Suitable materials for a capacitance reference surface 1102 include, but are not limited to glass, polymers, plastics, composite materials, another type of material, or combinations thereof.

The component layer 1104 may be located adjacent to the capacitance reference surface. The component layer 1104 may include components dedicated to the operation of the capacitance module 1100, including but not limited to central processing units, field-programmable gate arrays, graphics processing units, operational amplifiers, transistors, other components, and combinations thereof.

The component layer 1104 may include a set of capacitance electrodes 1108 disposed on a surface of the layer. The set of capacitance electrodes 1108 may form a capacitance sensor used to sense inputs to the capacitance module 1100 capacitively. In some examples, the capacitance module 1100 may incorporate a self-capacitance sensor. In other examples, a capacitance module may incorporate a mutual capacitance sensor. While in this example, the capacitance module 1100 includes a single set of capacitance electrodes 1108 disposed on the component layer 1104, in other examples, a capacitance module may include more than one set of capacitance electrodes, and capacitance electrodes may be disposed on multiple layers, multiple surfaces, or multiple substrates within the capacitance module.

The component layer 1104 may be mechanically coupled to the baseplate 1106 by one or more deflections spacers 1110. The deflection spacers 1110 may be configured to maintain a nominal separation between the component layer 1104 and the baseplate 1106 while permitting limited relative motion between the layers. In some examples, the deflection spacers 1110 are compliant structures that flex or deform in response to applied force. This compliance may allow the component layer 1104 and the capacitance reference surface 102 to deflect when pressure is applied by a user. The deflection spacers 1110 may also allow vibratory motion generated within the capacitance module 1100 to be transmitted to the capacitance reference surface 1102 while isolating or attenuating vibration transmitted to the baseplate 1106. Suitable deflection spacers may include elastomeric materials, spring structures, polymer posts, other structures capable of controlled mechanical compliance, or combinations thereof.

The baseplate 1106 may provide structural support for the capacitance module 1100. In some examples, the baseplate 1106 is a rigid or semi-rigid structure that anchors the capacitance module 1100 within an electronic device. The baseplate 1106 may be formed from a suitable material such as metal, plastic, a composite material, another suitable material, or combinations thereof.

An inductive coil 1112 may be disposed on an opposite surface of the component layer 1104 to the set of capacitance electrodes 1108. The inductive coil 1112 may be positioned to interact with a magnetic field source 1114 disposed on or adjacent to the baseplate 1106. In some examples, the inductive coil 1112 and magnetic field source 1114 may be axially aligned. In other examples, the inductive coil 1112 and magnetic field source 1114 may be offset from one another.

During operation of the capacitance module 1100, a drive signal may be applied to the inductive coil 1112, causing current to flow through the coil and generating a time-varying magnetic field. Interaction between the magnetic field generated by the inductive coil 1112 and the magnetic field source 1114 may produce a force which causes relative motion between the inductive coil and the magnetic field source. This relative motion may result in mechanical vibration of at least a portion of the capacitance module 1100. In some examples, the vibration produces a haptic effect perceivable by a user through the capacitance reference surface 1102, such as vibrations having a frequency in a range of approximately 100 Hz to 250 Hz. In other examples the vibration produces an audible output, such as vibrations having a higher frequency within an audio frequency range. In yet other examples, the inductive coil 1112 may be drive with a composite signal that produces both haptic and audio vibrations using the same actuator structure.

In some examples, the drive signal applied to the inductive coil 1112 is a composite drive signal that includes multiple signal components. The composite drive signal may include a haptic component which produces tactile vibrations and an audio component which produces audible vibrations. The composite drive signal may be generated by combining the haptic component and the audio component using any appropriate signal combination technique. In some examples, the composite drive signal is a superposition of the haptic component and the audio component. In other examples, the composite drive signal may be formed using modulation techniques. For example, the haptic component may be amplitude-modulated by the haptic component. In another example, frequency-domain techniques may be used in which the haptic component occupies a first frequency range, and the audio component occupies a second frequency range, where the components are combined into a single broadband signal. Other signal processing techniques may also be used, including but not limited to pulse-width modulation, time-domain multiplexing, other techniques, or combinations thereof. The resulting composite drive signal may cause the inductive coil 1112 to generate mechanical motion across a wide frequency range, enabling both haptic feedback and audio output using the same actuator.

In some examples, the capacitance module 1100 may selectively add, remove, attenuate, or otherwise modify individual components of the composite drive signal based on operating conditions, detected inputs, or system priorities. For example, in response to detecting a touch input on the capacitance reference surface 1102, the haptic component may be added and/or increased to the composite drive signal while the audio component is reduced, attenuated, and/or suppressed. In response to detecting a touch release or other change in input state, the audio component may be added or emphasized while the haptic component is attenuated or removed. In some examples, relative priorities may be assigned to the haptic component and the audio component, and the amplitude of the components may be adjusted based, at least in part, on the assigned priorities. Such selective control may allow the capacitance module 1100 to dynamically balance tactile and auditory feedback. The selective addition or removal of signal components may be performed in real time by a controller based on capacitance measurements, pressure measurements, application context, external audio signals, or combinations thereof.

In some examples, the capacitance module 1100 may receive an external audio signal generated by another component of the electronic device, such as an audio codec, media processor, or application executing on a host processor. The composite drive signal applied to the inductive coil 1112 may be generated, at least in part, on the external audio signal such that the audio component of the composite drive signal supplements the external audio output. For example, a portion of the external audio signal may be reproduced mechanically by the inductive coil 1112 to reinforce or augment sound produced by one or more dedicated speakers of the electronic device. In some examples, a low-frequency portion of the external audio signal may be extracted and used to generate a haptic component, while a higher-frequency portion is used to generate an audio component, thereby providing synchronized tactile and auditory feedback corresponding to the external audio. In other examples, the inductive coil 1112 may be driven with an audio component that mirrors, enhances, spatializes, or otherwise complements the external audio signal. Such supplementation may improve perceived audio quality, increase immersion, provide localized audio feedback near the input surface, or enable audio output in devices with limited space for conventional speakers.

FIG. 12 depicts an example of a user 1202 providing an input on the capacitance module 1100. In this example, the user 1202 applies an input to the capacitance reference surface 1102. In response to the input, the system produces haptic feedback 1206 and audio feedback 1204. The haptic feedback 1206 may be perceived by the user 1202 through the capacitance reference surface 1102, while the audio feedback 1204 may be perceived as sound radiated from the capacitance module 1100. A feedback vibration 1208 is generated within the capacitance module 1100 which propagates through one or more layers of the module to produce the haptic feedback 1206 and the audio feedback 1204.

As depicted, when the user 1202 presses downward on the capacitance reference surface 1102, the applied force is transmitted through the component layer 1104, causing the deflection spacers 1110 to deform. In response to the detected input, a drive signal is applied to the inductive coil 1112, causing interaction between the inductive coil 1112 and the magnetic field source 1114 and generating the feedback vibration 1208. The feedback vibration 1208 may propagate through the baseplate 1106, the deflection spacers 1110, and the component layer 1104 toward the capacitance reference surface 1102. This vibration may produce localized mechanical motion near the point of user contact, resulting in the haptic feedback 1206 felt by the user 1202. In addition, the same feedback vibration 1208 may excite surrounding structures or the capacitance reference surface 1102 to generate the audio feedback. 1204. In this way, a single inductive actuator may provide both tactile and audible feedback in response to a user input on the capacitance module 1100.

As shown in FIGS. 11-12, a system 1100 includes a component layer 1104, a set of deflection spacers 1110, a magnetic field source 1114, and a controller.

The substrate forms a rigid structure and includes a set of layers including a first spiral trace coiled in a first direction and a second spiral trace – coiled in a second direction opposite the first direction – cooperating with the first spiral trace to form a multilayer inductor; a set of touch sensors; and a touch sensor surface arranged over the set of touch sensors.

The set of deflection spacers support the substrate on the chassis; and are compliant normal to the touch sensor surface.

The first magnetic element defines a first polarity facing the first multi-layer inductor; and is configured to inductively couple to the first multi-layer inductor to displace the substrate relative to the chassis normal to the touch sensor surface.

The controller is configured to read a first set of electrical values from the set of touch sensors; interpret the first set of electrical values as a first touch input at a first location on the touch sensor surface; and, in response to detecting the first touch input, drive a first oscillating voltage, according to a first haptic signal, across the first multi-layer inductor during a first haptic feedback cycle to induce alternating magnetic coupling between the first multi-layer inductor and the first magnetic element and to oscillate the substrate, the first haptic signal including a haptic component at a first frequency and an audible component at a second frequency greater than the first frequency.

In one variation, the controller is further configured to drive a second oscillating voltage, according to a second audio signal, across the first multi-layer inductor during a first audio feedback cycle to induce alternating magnetic coupling between the first multi-layer inductor and the first magnetic element and to oscillate the substrate, the second audio signal including a second audio component at a third frequency greater than the first frequency.

Generally, the system 1100 for a human-computer interface includes a touch sensor, a multi-layer inductor, a set of deflection spacers, a magnetic element, and a controller. These elements cooperate to form a touch sensor configured to detect locations and/or force magnitudes of touch inputs; to output haptic feedback within a first frequency range (e.g., 100-400Hz) responsive to touch inputs; to output audible feedback within a second frequency range (e.g., 400-2000Hz) to augment haptic feedback responsive to touch inputs; and/or to output audible signals within the second frequency range (e.g., 100-400Hz).

In particular, the substrate includes PCB (e.g., rigid fiberglass PCB) formed via a set of layers. Upper layers of the set of layers include an array of drive and sense electrodes that cooperate to form two-dimensional touch sensor and output electrical signals representing proximity of external (conductive) objects. Additionally, lower layers of the set of layers include interconnected spiral traces that cooperate to form the multi-layer inductor. More specifically, the lower layers of the substrate include sets of fabricated spiral traces connected by vias to form the multi-layer inductor below the capacitive touch sensor; and the overlay, arranged on the substrate of the capacitive touch sensor, defining a planar touch sensor surface.

The substrate is mounted and supported within a receptacle of a chassis of a computing device via a set of deflection spacers. The deflection spacers include elastic material (e.g., of a particular durometer) that deform (e.g., compress, elongate) along their axes (i.e., normal to the touch sensor surface) and thus enable the substrate to move (i.e., oscillate, vibrate) vertically within the receptacle of the chassis.

The magnetic elements are arranged within (e.g., rigidly coupled to, bonded to) the receptacle, face the multi-layer inductor, and magnetically couple to the multi-layer inductor to apply a vertical force to the substrate when current is driven through the multi-layer inductor, thereby deforming the set of deflection spacers and moving the substrate vertically within the receptable.

Generally, during the scan cycle, the controller may read electrical (e.g., capacitive) values from drive and sense electrodes of the touch sensor; detect presence of an input (e.g., a finger, a stylus) on the touch sensor surface; and interpret a location of the input on the touch sensor surface based on these electrical values.

During a haptic feedback cycle and in response to detecting the input, the controller may retrieve a haptic feedback command, such as a predefined digital command representing signals oscillating at a frequency within a tactile frequency domain (e.g., 100-400Hz) and signals oscillating at frequencies within an audible frequency domain (e.g., 400-2000Hz), wherein these signals in combination are analogous to physical oscillations of a mechanical button, a mechanical trackpad, or a mechanical key, etc. and audible sounds produced by a mechanical button, a mechanical trackpad, or a mechanical key, etc. during actuation.

The controller then outputs the haptic feedback command to a driver (e.g., a digital to analog driver) that transforms the signals in this haptic feedback command into an oscillating electrical signal driven through the multi-layer inductor, thereby inducing an oscillating magnetic field through the multi-layer inductor. The multi-layer inductor thus magnetically couples to the magnetic element, which induces oscillating vertical forces between the multi-layer inductor and the magnetic element at frequencies – and amplitudes – corresponding to signals defined in the haptic feedback command.

The set of deflection spacers deflect (i.e., compress, extend) vertically under these oscillating vertical forces, thereby enabling the substrate and the touch sensor surface to oscillate vertically within the chassis.

Such lower-frequency oscillations of the touch sensor surface within the tactile frequency domain may thus transfer from the touch sensor surface into a finger, palm, or stylus in contact with the touch sensor surface and may thus be tactilely perceived by a user.

Similarly, such higher-frequency oscillations of the touch sensor surface within the audible frequency domain may transfer from the touch sensor surface into a volume of nearby air; travel through this air to the user’s ears; and may thus be audibly perceived by the user. Therefore, the controller may facilitate both audible and tactile haptic feedback from a single actuator without the implementation of moving components.

Furthermore, a variety of audible-range signals paired with different tactile-range signals may yield distinct audible and haptic feedback to produce different – and controlled – experiences for inputs on the same touch sensor surface. For example, the system may replicate a mechanical (e.g., mechanical switch, tactile switch, full-travel) keyboard with auditory signals between 2,000Hz and 6000Hz and haptic (or tactile) signals between 20Hz and 100Hz. In another example, the system may replicate a scissor-switch (e.g., membrane-actuated, non-mechanical) keyboard with auditory signals between 500Hz to 1,500Hz and haptic (or tactile) signals between 100Hz to 200Hz. In yet another example, the system may replicate an opto-mechanical or magnetic (e.g., hybrid-mechanical, optical switch, short-throw actuation) keyboard with auditory signals between 1,000Hz to 8,000Hz and haptic (or tactile) signals between 80Hz to 250Hz.

In one variation, the controller may retrieve an audio feedback command, such as a predefined digital command representing signals oscillating at a frequency within an audible frequency domain (e.g., 400-2000Hz), such as to augment (or in replacement of) audio output by an external speaker coupled to the controller or arranged in the chassis when the controller detects absence of a touch (e.g., finger, stylus, palm) input on the touch sensor surface.

For example, the system may define a touchpad within a laptop. During an audio stream output by dedicated speakers in the laptop, the controller reads signals from drive and sense electrodes; and detects absence of touch inputs on the touch sensor surface based on these signals. Given absence of touch inputs on the touch sensor surface, the controller may then augment audio output by the dedicated speakers in the laptop with vibration of the substrate at frequencies proportional to frequencies in the audio stream.

In particular, the controller may access a digital audio stream (e.g., from a GPU associated with a laptop); and output the digital audio stream to a driver, which transforms this digital audio stream into an oscillating electrical signal driven through the multi-layer inductor, thereby inducing an oscillating magnetic field through the multi-layer inductor. The multi-layer inductor thus magnetically couples to the magnetic element, which induces oscillating vertical forces between the multi-layer inductor and the magnetic element at frequencies – and amplitudes – corresponding to audible signals represented in the digital audio stream

The set of deflection spacers deflect (i.e., compress, extend) vertically under these oscillating vertical forces, thereby enabling the substrate and the touch sensor surface to oscillate vertically within the chassis.

These oscillations of the touch sensor surface within the audible frequency domain may transfer from the touch sensor surface into a volume of nearby air and travel through this air to the user’s ears and may thus be audibly perceived by the user.

In another variation, the controller accesses an audio stream defining signals within both the audible and the tactile range. The controller may then oscillate the substrate according to audio stream signals in the audible range in response to detecting absence of a touch input on the touch sensor surface. Alternatively, the controller may oscillate the substrate according to audio stream signals in both the audible and tactile ranges in response to detecting a touch input on the touch sensor surface. Accordingly, the controller may selectively output lower-frequency haptic signals transferred into a hand, palm, or finger of the user and may increase perceived volume of lower-frequency audio (i.e., “bass”) output by the system.

Generally, the system outputs a flat (i.e., consistent) response. Therefore, the system may combine a first haptic signal component and a second auditory signal component into a single haptic signal and drive the oscillating voltage through the inductor to actuate a simultaneous haptic and auditory response.

Accordingly, the system 1100 may oscillate the substrate, responsive to touch inputs on the touch sensor surface and normal to the surface, according to both (low) haptic frequencies and (high) auditory frequencies to output an augmented audio-haptic response during a first haptic feedback cycle.

In one implementation, the system 1100 may include a substrate that forms a rigid structure and includes a set of layers; and a touch flex layer arranged over the first set of layers. The set of layers may include a set of conductive layers etched to form a set of conducted traces; a substrate layer arranged below the stack of conductive layers; a set of vias that connect the set of conductive traces through the substrate layers; and a set of cutouts fabricated on the set of conductive layers within the set of conducted traces to form a unitary cutout on the set of layers.

In particular, a top conductive layer and/or second conductive layer of the touch flex layer may include a set of traces that cooperate to form an array (e.g., a grid array) of drive and sense electrode pairs within a touch sensor. Subsequent conductive layers of the set of layers below the touch sensor may include interconnected spiral traces that cooperate to form a single- or multi-core, single- or multi-winding, multi-layer inductor.

In one implementation, the substrate includes a touch flex layer. In this implementation, the touch flex layer may include first and second conductive layers that include columns of drive electrodes and rows of sense electrodes (or vice versa) that terminate in a grid array of drive and sense electrode pairs on a top layer of the touch flex layer. The touch flex layer may be a flexible PCB layer of a predetermined height (e.g., 100-150 um) that is arranged between a set of layers and the set of touch sensors. In one variation of this implementation, the touch flex layer may be a single-layer flex circuit. In another variation of this implementation, the touch flex layer may be a double-sided flex circuit. In yet another variation of this implementation, the touch flex layer may be a multi-layer flex circuit.

In one implementation, the first and second conductive layers of the touch flex layer of the substrate includes columns of drive electrodes and rows of sense electrodes (or vice versa) that terminate in a grid array of drive and sense electrode pairs on a top conductive layer of the touch flex layer.

During a scan cycle, a controller may serially drive the columns of drive electrodes; serially read electrical values (e.g., voltage, capacitance rise time, capacitance fall time, resonant frequency) – representing capacitive coupling between drive and sense electrode pairs – from the rows of sense electrodes; and detect a first input at a first location (e.g., an (x, y) location) on the touch sensor surface based on deviation of electrical values – read from a subset of drive and sense electrode pairs adjacent the first location – from baseline capacitance-based electrical values stored for this subset of drive and sense electrode pairs. For example, the controller may implement mutual capacitance techniques to read capacitance values between these drive and sense electrode pairs and interpret inputs on the touch sensor surface based on these capacitance values.

The array of drive and sense electrode pairs on the first and second conductive layers of the touch flex layer of the substrate and the force-sensitive layer may thus cooperate to form a capacitive touch sensor readable by the controller to detect lateral and longitudinal positions of inputs (e.g., fingers, styluses, palms) on the touch sensor surface.

In one implementation, the system 1100 includes a touch sensor layer interposed between the touch sensor and the substrate; including a set of drive and sense electrode pairs arranged across the touch sensor layer; and including a tail extending from the touch sensor layer and including a set of traces electrically coupled to the set of drive and sense electrode pairs. Additionally, the tail extends from a perimeter side edge of the touch sensor layer; and is connected to the controller, which may be arranged external the substrate and/or arranged on the bottom surface of the substrate. The controller may thus read electrical values (e.g., voltage, capacitance rise time, capacitance fall time, resonant frequency) – representing capacitive coupling between drive and sense electrode pairs – from the rows of sense electrodes; and detect a first input at a first location (e.g., an (x, y) location) on the touch sensor surface based on deviation of electrical values – read from a subset of drive and sense electrode pairs adjacent the first location – from baseline capacitance-based electrical values stored for this subset of drive and sense electrode pairs.

Accordingly, the system 1100 may include a touch sensor layer capable of detecting presence of touch inputs applied to the substrate; and detecting positions of touch inputs applied to the substrate.

Generally, the system 1100 may include a multi-layer inductor formed by a set of interconnected spiral traces fabricated directly within conductive layers within the substrate.

Generally, the total inductance of a single spiral trace may be limited by the thickness of the conductive layer. Therefore, the system 100 may include a stack of overlapping, interconnected spiral traces fabricated on a set of adjacent layers of the substrate to form a multi-layer, multi-turn, and/or multi-core inductor that exhibits greater inductance – and therefore greater magnetic coupling to the magnetic element – than a single spiral trace on a single conductive layer of the substrate. These spiral traces may be coaxially aligned about a common vertical axis (e.g., centered over the magnetic element) and electrically interconnected by a set of vias through the intervening substrate layers of the substrate.

Furthermore, the substrate may include conductive layers of different thicknesses. Accordingly, spiral traces within thicker conductive layers of the substrate may be fabricated with narrower trace widths and more turns, and spiral traces within thinner conductive layers of the substrate may be fabricated with wider trace widths and fewer turns in order to achieve similar electrical resistances within each spiral trace over the same coil footprint. For example, lower conductive layers within the substrate may include heavier layers of conductive material (e.g., one-ounce copper approximately 35 microns in thickness) in order to accommodate narrower trace widths and more turns within the coil footprint in these conductive layers, thereby increasing inductance of each spiral trace and yielding greater magnetic coupling between the multi-layer inductor and the magnetic element during a haptic feedback cycle. Conversely, in this example, the upper layers of the substrate – which include many (e.g., thousands of) drive and sense electrode pairs of the touch sensor – may include thinner layers of conductive material.

In one implementation, the substrate includes an even quantity of spiral traces to form a substrate with a single-coil inductor.

In one example, the substrate includes a touch sensor layer containing an array of drive and sense electrode pairs; a first rigid layer; a second rigid layer; a third rigid layer; and a fourth (e.g., a bottom) rigid layer. In this example, the first rigid layer includes a first spiral trace coiled in a first direction and defining a first end and a second end. In particular, the first spiral trace may define a first planar coil spiraling inwardly in a clockwise direction from the first end at the periphery of the first planar coil to the second end proximal a center of the first planar coil. The second layer includes a second spiral trace coiled in a second direction opposite the first direction and defining a third end – electrically coupled to the second end of the first spiral trace – and a further end. In particular, the second spiral trace may define a second planar coil spiraling outwardly in the clockwise direction from the third end proximal the center of the second planar coil to the fourth end at a periphery of the second planar coil.

Similarly, the third layer includes a third spiral trace coiled in the first direction and defining a fifth end – electrically coupled to the fourth end of the second spiral trace – and a sixth end. In particular, the third spiral trace may define a third planar coil spiraling inwardly in the clockwise direction from the fifth end at the periphery of the third planar coil to the sixth end proximal a center of the third planar coil. The fourth layer includes a fourth spiral trace coiled in the second direction defining a seventh end – electrically coupled to the sixth end of the first spiral trace – and an eighth end. In particular, the fourth spiral trace may define a fourth planar coil spiraling outwardly in the clockwise direction from the seventh end proximal the center of the fourth planar coil to the eighth end at a periphery of the fourth planar coil.

Accordingly, the second end of the first spiral trace may be coupled to the third end of the second spiral trace by a first via; the fourth end of the second spiral trace may be coupled to the fifth end of the third spiral trace by a second via; the sixth end of the third spiral trace may be coupled to the seventh end of the fourth spiral trace by a third via; and the first, second, third, and fourth spiral traces may cooperate to form a single-core, four-layer inductor.

The controller (or a driver) may be electrically connected to the first end of the first spiral trace and the eighth end of the fourth spiral trace (or “terminals” of the multi-layer inductor); and may drive these terminals of the multi-layer inductor with an oscillating voltage during a haptic feedback cycle in order to induce an alternating magnetic field through the multi-layer inductor, which couples to the magnetic elements and oscillates the substrate within the chassis. In particular, when the controller drives the multi-layer inductor at a first polarity, current may flow in a continuous, clockwise direction through the first, second, third, and fourth spiral traces to induce a magnetic field in a first direction around the multi-layer inductor. When the controller reverses the polarity across terminals of the multi-layer inductor, current may reverse directions and flow in a continuous, counter-clockwise direction through the first, second, third, and fourth spiral traces to induce a magnetic field in a second, opposite direction at the multi-layer inductor.

Generally, the system 1100 includes a magnetic element rigidly coupled to the chassis beneath the multi-layer inductor; and configured to magnetically couple to the multi-layer inductor during a haptic feedback cycle, thereby applying an oscillating force to the multi-layer inductor and oscillating the substrate – and therefore the touch sensor surface – during this haptic feedback cycle.

In particular, the spiral traces within the multi-layer inductor may span a coil footprint, such as a rectangular or ellipsoidal footprint including long sides parallel to a primary axis of the multi-layer inductor; and short sides parallel to a secondary axis of the multi-layer inductor. For example the substrate may be 5 inches in width and 3 inches in length; the touch sensor surface may span an area approximately 5 inches by 3 inches over the substrate; and the coil footprint of each single-core multi-layer inductor within the substrate may be approximately 1.5 inches in length and 0.5 inches in width with the primary axis of the single-core multi-layer inductor 122 extending laterally across the width of the substrate.

Generally, the first magnetic element is arranged relative the multi-layer inductor to induce an oscillating force – between the multi-layer inductor and the first magnetic element – normal to the touch sensor surface such that the substrate oscillates vertically within the chassis during a haptic feedback cycle.

In one implementation, the system 1100 may include the first magnetic element arranged within the chassis; defining a first magnetic polarity; facing the multi-layer inductor, centered under the multi-layer inductor; and extending laterally across the primary axis of the multi-layer inductor. The first magnetic element may thus generate a magnetic field that extends predominantly vertically toward the multi-layer inductor. More specifically, the first magnetic element may generate a magnetic field that extends predominantly normal the substrate and proximal the center of the multi-layer inductor. The controller may then drive a positive voltage through the multi-layer inductor during a haptic feedback cycle, and the multi-layer inductor may generate a magnetic field that extends vertically through the substrate in a first vertical direction, which repels the first magnetic element (arranged with the first polarity facing the multi-layer inductor); and yields a first vertical force in a first vertical direction. When the controller then reverses the voltage across the multi-layer inductor during this haptic feedback cycle, the multi-layer inductor may generate a magnetic field that extends vertically through the substrate in a second, opposite vertical direction. The magnetic field is configured to attract the first magnetic element; yield a second vertical force in a second, opposite vertical direction; and draw the substrate downward and back toward the first magnetic element.

Therefore, by oscillating the polarity of the multi-layer inductor, the controller may induce oscillating magnetic coupling (i.e., alternating attractive and repelling magnetic forces) – normal to the touch sensor surface – between the multi-layer inductor and the first magnetic element; and thus vertically oscillate the substrate and the touch sensor surface.

In particular, the magnetic element and the multi-layer inductor may cooperate to vertically oscillate the substrate relative to the chassis and normal to the touch sensor surface within a frequency domain tactilely perceptible to a user; and emit auditory feedback within a frequency domain audibly perceptible to the user. By vibrating the substrate and the touch sensor surface according to haptic and audible patterns characteristic of a particular key or button type or format, the system 1100 may emulate the tactile and audible experience of depressing such a type or format of key or button via a structure with no moving parts. The system 1100 may also dynamically switch between such emulation of different types of formats of keys and/or buttons.

In one implementation, the system 1100 further includes a set of deflection spacers (e.g., short elastic columns or buttons, adhesive films) coupled to a bottom layer of the substrate and configured to support the substrate on the chassis (or baseplate). In particular, each deflection spacer may include a sensor layer arranged across the deflection spacer and exhibiting changes in a height of the deflection spacer responsive to a load on the touch sensor surface that compresses the deflection spacer against the chassis.

Accordingly, in this implementation, the controller may read a second set of electrical values (e.g., electrical changes, current changes) – representing compression of the set of deflection spacers against the baseplate– from the sensor layer; interpret a first input based on deviations of electrical values (e.g., a change in direction) from baseline electrical values; and drive an oscillating voltage across the multi-layer inductor during a haptic feedback cycle in response to detecting a change in a height of a deflection spacer (e.g., via a change in direction of electrical value at the sensor).

In one implementation, each deflection spacer includes a coupon bonded to the bottom face of the substrate; and a bottom face coated or including a low-friction material configured to slide across the base of the receptacle to enable the substrate to translate laterally in the receptacle during a haptic feedback cycle while also vertically supporting the substrate over the receptacle. In yet another implementation and as described below, each deflection spacer may be mounted to a spring or flexure element – which is mounted to the chassis– that enables the deflection spacer to move laterally within the receptacle while vertically supporting the substrate within the receptacle.

In this configuration, the bottom conductive layer of the substrate may include a pair of interdigitated drive and sense electrodes in each deflection spacer location about the perimeter of the substrate. Furthermore, each deflection spacer may include a layer of force-sensitive material facing the pair of interdigitated drive and sense electrodes at this deflection spacer location on the substrate. The controller may thus read an electrical resistance (or a voltage representing electrical resistance) across a pair of sensor traces at a deflection spacer location; and transform this resistance into a force magnitude carried from the touch sensor surface, into the substrate, and into the adjacent the deflection spacer. In particular, the system 1100 may include multiple deflection spacers, and the controller may read electrical values from sensor traces at each deflection spacer location; convert these electrical values into force magnitudes carried by each deflection spacer; and aggregate these force magnitudes into a total force magnitude of an input on the touch sensor surface.

Therefore, in this configuration, the substrate may define a unitary structure including a dense array of drive and sense electrode pairs that form a touch sensor, a column of spiral traces that form a multi-layer inductor, and a sparse array of drive and sense electrode pairs that form a set of force sensors that support the substrate on the chassis.

In another implementation, the set of deflection spacers may define a material of a particular durometer such that a deflection spacer, in the set of deflection spacers, may deform (e.g., mushroom, bend) responsive to force applied on the touch sensor surface and/or the substrate including a first touch input. Additionally, in this implementation, the set of deflection spacers may define a biconcave profile in response to release of the first touch input (e.g., release of force applied on the touch sensor surface).

Accordingly, in this implementation, the set of deflection spacers may enable uniform movement (e.g., uniform oscillation) throughout the substrate during a haptic feedback cycle. Therefore, during a haptic feedback cycle, the set of deflection spacers may enable the system 1100 to output a “flat” or consistent haptic (or tactical) frequency.

In one implementation, the system 1100 defines a resonance frequency that matches a target frequency for a haptic feedback cycle. More specifically, the system 1100 may define a target resonance frequency such that, during a first haptic feedback cycle, the controller may drive a first oscillating voltage, according to a first haptic signal, across the first multi-layer inductor during a first haptic feedback cycle to oscillate the substrate, the first haptic signal including a haptic component at the resonant frequency and an audible component at a second frequency greater than the first frequency.

In one example, the substrate defines a target thickness (or mass) to adjust a total mass of the system 1100 such that the system 1100 may define the target resonance. In another example, the set of deflection spacers may define a target material (e.g., silicone, polyurethane, nitrile rubber) of a target durometer (e.g., Shore 50A, Shore 60A). In this example, the set of deflection spacers may define the target durometer such that the set of deflection spacers may transfer a high yield of haptic feedback at the resonant frequency; and deform against a first touch input.

Therefore, as described in the foregoing examples, the system 1100 may define a resonant frequency such that, when the controller drives oscillating voltage according to a first haptic signal, the first haptic signal including a first haptic component defining the resonant frequency, the system 1100 may output a consistent haptic feedback response; amplify haptic feedback strength; and output a minimum energy into the haptic feedback cycle.

In one implementation, the controller may, in response to detecting a first touch input based on electrical signals from the array of touch sensors on the touch surface disable an audio-based drive signal to the inductor; and output a haptics drive signal to the inductor to induce the first haptic feedback cycle.

More specifically, the controller may access a first set of electrical values from the array of touch sensors; detect a first change in electrical value, in the first set of electrical values, including a first voltage of a first polarity across the array of touch sensors (or a subset of touch sensors); register a first touch input on the substrate in response to detecting the first voltage of the first polarity across the array of touch sensors; interpret a first force magnitude for the first touch input based on the first voltage of the first polarity; and trigger the oscillating voltage, according to a first haptic signal, across the first multi-layer inductor during the first haptic feedback cycle in response to the first force magnitude exceeding a target force magnitude, the first haptic signal including a first haptic component of a first frequency.

In one example, the controller ceases audio playback from a speaker (or a set of speakers) external to the system 1100 in response to detecting the first touch input. More specifically, in response to detecting the first touch input, the controller may temporarily disable (or “pause”) audio feedback, such as by activating a resistor between the audio drive signal and the speaker and/or silencing an external speaker.

In another example, the controller ceases audio feedback from the system 1100 in response to detecting the first touch input on the touch sensor surface.

In this implementation, the controller may further resume audio feedback in response to detecting release of the first touch input (e.g., by detecting a second change in electrical signal at the touch sensor).

For example, the controller may detect a second voltage of a second polarity, opposite the first polarity, across the first multi-layer inductor at a second time succeeding the first time; register release of the first touch input from the substrate in response to detecting the second voltage at the second polarity across the first multi-layer inductor; and trigger audio feedback through external speakers.

In a similar example, the controller may detect a second voltage of a second polarity, opposite the first polarity, across the first multi-layer inductor at a second time succeeding the first time; register release of the first touch input from the substrate in response to detecting the second voltage at the second polarity across the first multi-layer inductor; and drive the first oscillating voltage across the first multi-layer inductor according to the first haptic signal including a first haptic component and a first audible component. Therefore, in this example, the controller may resume audio feedback in response to registering release of the first touch input.

In yet another implementation, the controller may selectively isolate a first haptic component from a haptic feedback signal; and drive the oscillating voltage across the first multi-layer inductor according to the first haptic component.

More specifically, the controller may access the first set of electrical values, from the first multi-layer inductor, representing voltage across the first multi-layer inductor; detect a first change in electrical value including a first voltage of a first polarity across the first multi-layer inductor at the first time; interpret the first change in electrical value as a first touch input ; and drive an oscillating voltage to the multi-layer inductor during a haptic feedback cycle including haptic feedback and omitting audible feedback by oscillating at first frequency including a low, inaudible frequency (e.g., 20 Hz). Furthermore, the controller may filter the first haptic signal for low-frequency signals (e.g., a haptic component); and filter out high-frequency signals (e.g., an audible component) from the first haptic signal. More specifically, the controller may implement low-pass filters to isolate a first haptic component of a haptic signal, the first haptic component representing a low-frequency band (e.g., below 300 Hz); and drive the oscillating voltage across the first multi-layer inductor to output a first haptic feedback response.

Generally, the controller may drive a first oscillating voltage across the inductor according to a first haptic signal including a first haptic component at a first frequency and a second auditory component at a second frequency greater than the first frequency.

More specifically, the controller may drive a first oscillating voltage, according to a first haptic signal, across the first multi-layer inductor during a first haptic feedback cycle to induce alternating magnetic coupling between the first multi-layer inductor and the first magnetic element and to oscillate the substrate, the first haptic signal including a haptic component at a first frequency (e.g., to induce haptic, or vibrating, feedback) and an audible component at a second frequency greater than the first frequency (e.g., to induce audio feedback via oscillations).

In one example, the system 1100 may trigger a first oscillating voltage at a first frequency (e.g., 20 Hz) across the first multi-layer inductor during the first haptic feedback cycle to induce alternating magnetic coupling between the first multi-layer inductor and the first magnetic element and to oscillate the substrate and/or a cover layer arranged over the substrate. Concurrently, the system 1100 may trigger a second oscillating voltage at a second frequency (e.g., 2 kHz), greater than the first frequency (i.e., at a perceivable audible frequency), concurrent the first oscillating voltage during the first haptic feedback cycle to induce alternating magnetic coupling between the first multi-layer inductor and the first magnetic element and to broadcast an audible feedback tone.

In one implementation, the system 1100 produces an augmented, or combined, haptic response via superimposition of a first frequency representing a haptic component, and a second frequency representing an auditory component. More specifically, the system 1100 drives a first oscillating voltage, modulated according to a combination of the first haptic signal at a first frequency and the second auditory signal at a second frequency, the first haptic signal and second auditory signal superimposed into a single drive signal, across a first inductor, to induce alternating magnetic coupling between the first inductor and the first magnetic element to oscillate the substrate at the first frequency and the second frequency.

In one example, the system 1100 may implement signal combination methods to combine the first haptic component and the second audible component to produce a single seamless haptic output including a first vibratory feedback response and a first audible feedback response. Similarly, the system 1100 may implement a digital-to-analog converter (DAC) to combine the first haptic component and the second audible component into the first haptic signal.

In another implementation, the system 1100 may implement amplitude modulation techniques to selectively modulate between the first haptic component and the second audible component. More specifically, the system 1100 (e.g., the controller) may modulate the second audible component according to the first haptic component to adjust the amplitude, or strength, of the first audible component to synchronize the first component and the second component of the first haptic signal. In one example, a user may adjust a first ratio of total signal power allocated to the first auditory response. Then, based on the first ratio, the controller may modulate the amplitude of the second auditory component of the first haptic signal to adjust a strength (or volume) of the auditory response.

Accordingly, in this implementation, the system 1100 may drive oscillating voltage through a single, multi-layer inductor based on the first haptic signal to produce concurrent haptic and auditory feedback response, wherein the system 1100 dynamically controls (or “tunes”) the relative amplitudes of these haptic and auditory feedback responses, such as based on ambient noise conditions, force magnitude of an input applied to the touch sensor surface, and/or a user setting.

In one variation, a system may include a first coil; a first magnetic element facing the first coil; a second coil, offset from the first coil; and a second magnetic element facing the second coil. For example, the first coil and the first magnetic element may be located proximal a left side of the touch sensor surface; and the second coil and the second magnetic element may be located proximal a right side of the touch sensor surface.

In this variation, the controller may implement stereo audio-haptics by driving a first oscillating voltage, according to a left-stereo audio signal, across the first coil to induce alternating magnetic coupling between the first coil and the first magnetic element and thus generate left-stereo audible sounds (predominantly) via oscillation of a left side the substrate; and concurrently driving a second oscillating voltage, according to a right-stereo audio signal, across the second coil to induce alternating magnetic coupling between the second coil and the second magnetic element and thus generate right-stereo audible sounds (predominantly) via oscillation of a right side the substrate.

Furthermore, in response to detecting an input on the left (or right) side of the touch sensor surface during stereo audio output from the system, the controller may inject an haptic signal – including a low-frequency haptic component and a higher-frequency audible component – into the left-stereo (or right-stereo) audio signal in order to maintain stereo audible output from the system via oscillation of the left and right sides of the substrate; while also (briefly) outputting haptic feedback and corresponding audible feedback near the site of the input on the left (or right) side of the substrate.

In one implementation, the controller may drive a first oscillating voltage across the first inductor according to a first haptic signal including a first haptic component at a first frequency; and drive a second oscillating voltage across a second inductor according to the first haptic signal including a second audible component at a second frequency greater than the first frequency.

More specifically, the system 1100 may implement frequency division methods to filter the first haptic component from the first haptic signal; trigger a first oscillating voltage through the first inductor to alternate magnetic coupling between the first multi-layer inductor and the first magnetic element and to oscillate the substrate according to the first frequency; filter the second audible component from the first haptic signal; and trigger a second oscillating voltage through the second inductor to alternate magnetic coupling between the second multi-layer inductor and a second magnetic element and to oscillate the substrate according to the second frequency.

Additionally, or alternatively, the system 1100 may further filter (e.g., via frequency division) the second audible component of the first haptic signal based on frequency bands of the second audible component.

For example, the system 1100 may filter the second audible component for low-frequency bands; and drive a second oscillating voltage, according to the low-frequency bands (e.g., 60-250 Hz), through a second multi-layer inductor located proximal a touchpad of a device. In this example, the system 1100 may further drive the first oscillating voltage, based on the first haptic component of the first haptic signal, through the second multi-layer inductor located proximal the touchpad of the device to enable the touchpad to act as a “subwoofer” of the system 100 and output a combined haptic and auditory (or “bass”) feedback response during the first haptic feedback cycle. Furthermore, in this example, the system 1100 may filter the second audible component for high-frequency bands; and drive a third oscillating voltage, according to the high frequency bands (e.g., 4-20 kHz), through a first multi-layer inductor located proximal a perimeter of the substrate.

The system 1100 is described herein as using frequency division techniques to filter frequency bands from the first haptic signal. However, the system 1100 may additionally or alternatively implement a series of resistors and/or potentiometers to direct components of the first haptic signal to target locations within the system 1100.

Accordingly, in this implementation, the system 1100 may filter the first haptic signal based on frequency bands; and direct components of the first haptic signal to target locations within the system 1100 (e.g., multiple speakers, a set of inductors) to output a target haptic response, such as a combined haptic and auditory 'subwoofer' response on a touchpad of a device and an auditory feedback response through a speaker or set of speakers in the device.

In one example, the system 100 may access an audio stream output by a processing unit (e.g., CPU, GPU) in a computing device, such as received from a game loaded (e.g., open on a web browser, downloaded, connected to) on the computing device. The system 1100 may then receive a selection of audio signals from the processing unit and selectively output audible- and/or haptic-frequency components of these audio signals; and/or haptic feedback responsive to touch inputs on the touch sensor surface.

More specifically, the system 1100 may access a set of audio signals from a processing unit, the set of audio signals originating from an application on a device; augment each audio signal in the set of audio signals with a complementary haptic feedback signal to generate a set of haptic feedback signals; access a first condition related to a first audio signal in the set of audio signals; and, in response to detecting a first touch input in the set of touch sensors and in response to detecting the first condition related to the first audio signal, drive a first oscillating voltage, according to a first haptic signal associated with the first audio signal and augmented with the complementary haptic feedback signal, across the first multi-layer inductor during a first haptic feedback cycle to induce alternating magnetic coupling between the first multi-layer inductor and the first magnetic element and to oscillate the substrate.

Accordingly, in this example, the system 1100 may oscillate the substrate according to a first frequency associated with the first audio signal to produce a target audio output related to the application; and a second frequency, less than the first frequency, associated with the haptic feedback signal to produce a haptic (or vibratory) response.

In this example, the system 1100 accesses a first condition (e.g., a first player position, a first movement) related to a first audio signal (e.g., player breathing, walking on grass) in the set of audio signals and, in response to detecting a first touch input (e.g., on a touchpad of the device) in the set of touch sensors and in response to detecting the first condition (e.g., the first movement), received from the processing unit, related to the first audio signal, drive a first oscillating voltage, according to a first haptic signal associated with the first audio signal and augmented with the complementary haptic feedback signal, across the first multi-layer inductor during a first haptic feedback cycle to induce alternating magnetic coupling between the first multi-layer inductor and the first magnetic element; to oscillate the substrate; and to output the first audio signal (e.g., grass rustling) augmented with the first haptic feedback signal (e.g., a 100 Hz vibratory feedback response).

In another example, the system 1100 defines a keyboard structure including a set of keys defining a set of key locations.

In this example, each key in the set of keys may be associated with a target haptic signal including a target audio component and a target haptic component.

More specifically, the system 1100 accesses a set of target haptic signals; and assigns a particular target haptic signal in the set of target haptic signals to each key, in the set of keys, based on a key location, in the set of key locations, associated with the key.

Then, the controller may access a set of electric values, from a first touch sensor associated with a first key location for a first key; and, in response to detecting a first electrical value, in the set of electrical values, deviating from a baseline electrical value for the first key, registering a first touch input at the first key location. The controller may then, in response to detecting the first touch input on the first key, drive a first oscillating voltage, according to a first target haptic signal associated with the first key, across the first multi-layer inductor during a first haptic feedback cycle to induce alternating magnetic coupling between the first multi-layer inductor and the first magnetic element; to oscillate the first key; and to output the target audio signal augmented with the target haptic feedback signal.

More specifically, in this example, in response to detecting a first touch input on a first key (e.g., the spacebar), the controller may drive the first oscillating voltage, according to the first target haptic signal associated with the first key, across an array of multi-layer inductors patterned across the first key during a first haptic feedback cycle. Furthermore, during the first haptic feedback cycle, the first oscillating voltage induces alternating magnetic coupling between the array of multi-layer inductors and an array of magnetic elements (arranged below the array of multi-layer inductors) to oscillate the first key; and to output the target audio signal augmented with the target haptic feedback signal.

Additionally or alternatively, in this example, the controller may access the set of target haptic signals based on a configuration of the device; and assign a particular target haptic signal in the set of target haptic signals to each key, in the set of keys, based on a key location, in the set of key locations, associated with the key and the configuration of the device.

In a similar example, the substrate and the touch sensor surface define a button or key (e.g., of a keyboard).

In this example, the controller accesses a set of electrical values; and, in response to a first electrical value deviating from a baseline electrical value, interprets a first touch input (e.g., a first push-down on the button).

Then, in response to the first touch input, the controller drives the first oscillating voltage, according to the first haptic signal, across the multi-layer inductor in order to induce alternating magnetic coupling between the multi-layer inductor and the first magnetic element to oscillate the substrate relative the chassis to output a first audio signal augmented with a haptic feedback response according to the first haptic signal.

The controller then accesses a second set of electrical values; and, in response to a second electrical value deviating from the first electrical value (e.g., in an opposite direction), interprets the second electrical value as release of the first touch input. Then, in response to release of the first touch input, the controller ceases driving the first oscillating voltage to, therefore, ceasing output of the first audio signal and the haptic feedback response.

In yet another example, the substrate and the touch sensor surface define a fingerprint reader.

In this example, during a first scan cycle, the controller reads a first set of electrical values; and interprets locations and force magnitudes of inputs on the touch sensor surface based on these electrical values. In response to detecting a first touch input – such as at a force that exceeds a threshold force magnitude – on the touch sensor surface, the controller reads a second set of electrical values from the fingerprint reader to generate a first fingerprint image. In response to the first fingerprint image deviating from a target fingerprint image, the controller drives the first oscillating voltage, according to the first haptic signal, across the multi-layer inductor to induce alternating magnetic coupling between the multi-layer inductor and the first magnetic element to oscillate the substrate relative the fingerprint reader to output a first audio signal (e.g., “Womp”) augmented with a haptic feedback response according to the first haptic signal. More specifically, the first haptic signal may include a first haptic component defining a first frequency; and a second audible component defining a second frequency greater than the first frequency.

Additionally or alternatively, during a second scan cycle, the controller reads a third set of electrical values; and interprets locations and force magnitudes of inputs on the touch sensor surface based on these electrical values. In response to detecting a second touch input – that exceeds a threshold force magnitude – on the touch sensor surface, the controller reads a fourth set of electrical values from the fingerprint reader to generate a second fingerprint image. In response to the second fingerprint image matching the target fingerprint image, the controller drives the first oscillating voltage, according to a second haptic signal, across the multi-layer inductor to induce alternating magnetic coupling between the multi-layer inductor and the first magnetic element to oscillate the substrate relative the fingerprint reader to output a first audio signal (e.g., “Ding”) augmented with a haptic feedback response according to the first haptic signal. More specifically, the second haptic signal may include a third haptic component defining a third frequency; and a fourth audible component defining a fourth frequency greater than the second frequency.

Accordingly, in this example, the system 1100 may output a first response, including a first haptic response and a first audible response, in response to a fingerprint image deviating from a target fingerprint image; output a second response, including a second haptic response and a second audible response; and output a signal granting access to resources on the device, in response to a second fingerprint image matching the target fingerprint image.

In one variation, the substrate includes an array of force sensors configured to output signals representing forces applied to the touch sensor surface. For example, the substrate may include electrodes arranged adjacent each deflection spacer and configured to output capacitive, inductive, or resistive electrical values representative of forces carried by these deflection spacers.

In this variation, during a first scan cycle, the controller may access a set of electrical values from the array of force sensors; interpret a first force magnitude of a first force applied to the substrate based on these electrical values; associate this first force magnitude with a touch input – at a first position on the touch sensor surface – concurrently detected via the touch sensor; and register the first force as a first touch input at the first position if the first force magnitude exceeds a first threshold force magnitude, such as corresponding to a “click” input (e.g., 100 grams).

Accordingly, the controller may retrieve a first haptic signal – from memory – corresponding to “click” inputs and containing lower characteristic frequencies and lower characteristic amplitudes in the haptic and audible domains. The controller may then drive a first oscillating voltage according to this first haptic signal – across the multi-layer inductor to induce alternating magnetic coupling between the multi-layer inductor and the first magnetic element, thereby oscillating the substrate relative the chassis and outputting both haptic and audible feedback through the touch sensor surface responsive to this “click” input.

During a later scan cycle, the controller may similarly access a set of electrical values from the array of force sensors; interpret a second force magnitude of a second force applied to the substrate based on these electrical values; associate this second force magnitude with a touch input – at a second position on the touch sensor surface – concurrently detected via the touch sensor; and register the second force as a second touch input at the second position if the second force magnitude exceeds a second threshold force magnitude, such as corresponding to a “deep-click” input (e.g., 200 grams).

Accordingly, the controller may retrieve a second haptic signal – from memory – corresponding to “deep-click” inputs and containing higher characteristic frequencies and higher characteristic amplitudes in the haptic and audible domains. The controller may then drive a second oscillating voltage according to this second haptic signal – across the multi-layer inductor to induce alternating magnetic coupling between the multi-layer inductor and the second magnetic element, thereby oscillating the substrate relative the chassis and outputting both haptic and audible feedback through the touch sensor surface responsive to this “deep-click” input, which the user may perceive – both haptically and audibly – as different from feedback responsive to the earlier lower-force touch input.

Therefore, the controller may detect force magnitudes of touch inputs on the touch sensor surface and select, vary, or otherwise control amplitudes (or “volumes”) and/or frequencies of haptic and/or audio feedback output by the system 100 based on these force magnitudes.

The system is described herein as including a controller configured to, in response to detecting the first touch input, drive a first oscillating voltage, according to a first haptic signal, across the first multi-layer inductor during a first haptic feedback cycle to induce alternating magnetic coupling between the first multi-layer inductor and the first magnetic element and to oscillate the substrate normal to the surface of the touch sensor surface.

Additionally, or alternatively, the system includes a first coil and a first magnetic element, the first magnetic element facing the second coil and arranged in a horizontal oscillation configuration – such that the substrate oscillates in a plane parallel to the touch sensor surface – as described in U.S. Patent Application No. 17/191,631.

In this variation, the controller may drive a first oscillating voltage across the first coil during a first haptic feedback cycle according to a first haptic signal – including a haptic component at a first frequency and an audible component at a second frequency greater than the first frequency, as described above – in order to induce alternating magnetic coupling between the first coil and the first magnetic element and to oscillate the substrate parallel to the touch sensor surface.

The systems and methods described herein may be embodied and/or implemented at least in part as a machine configured to receive a computer-readable medium storing computer-readable instructions. The instructions may be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment may be embodied and/or implemented at least in part as a machine configured to receive a computer-readable medium storing computer-readable instructions. The instructions may be executed by computer-executable components integrated by computer-executable components integrated with apparatuses and networks of the type described above. The computer-readable medium may be stored on any suitable computer readable media such as RAMs, ROMs, flash memory, EEPROMs, optical devices (CD or DVD), hard drives, floppy drives, or any suitable device. The computer-executable component may be a processor, but any suitable dedicated hardware device may (alternatively or additionally) execute the instructions.

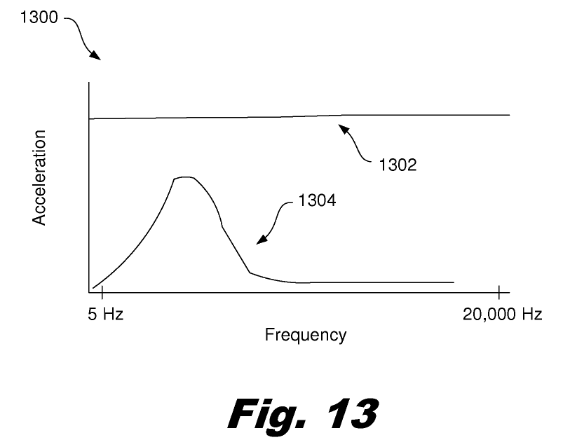

FIG. 13 depicts an example of an acceleration-frequency graph 1300 in accordance with the disclosure. In this example, the vertical axis represents acceleration, and the horizontal axis represents frequency over a range from approximately 5 Hz to approximately 20,000 Hz. A first curve 1302 represents a response characteristic of an inductive coil actuator, such as the inductive coil 1112 described herein. As shown by the first curve 1302, the inductive coil actuator is capable of producing mechanical vibrations with a substantially consistent acceleration across a wide frequency range, including both low-frequency haptic ranges and higher-frequency audio ranges. This substantially flat response may enable the same actuator to generate perceptible haptic feedback at lower frequencies and audible output at higher frequencies, as well as composite signals that include both components simultaneously.

A second curve 1304 represents a response characteristic of another type of actuator, such as a piezoelectric actuator or other resonant haptic device. As illustrated by the second curve 1304, such actuators may exhibit a limited frequency response, with relatively high acceleration over a narrow frequency band and significantly reduced acceleration outside of that band, particularly at higher frequencies. This limited response may restrict the ability of such actuators to produce audible output or broadband composite signals. Accordingly, FIG. 13 illustrates an advantage of the inductive coil actuator used in the capacitance module 1100, namely its ability to provide a wide and substantially uniform frequency response that supports combined haptic and audio output using a single actuator structure.

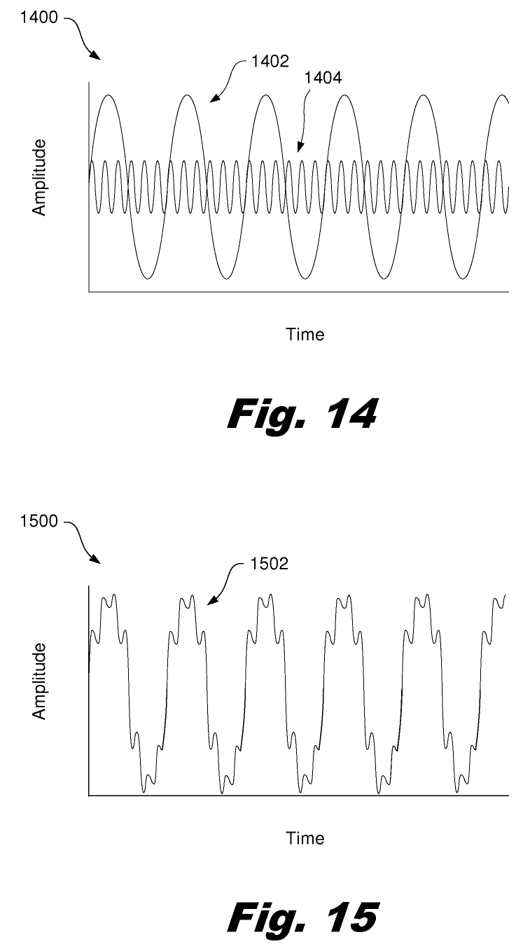

FIG. 14 depicts an example of a signal graph 1400 in accordance with the disclosure, illustrating signal components that may be used to generate a composite drive signal for driving an actuator, such as the inductive coil 1112 described herein. In this example, the vertical axis represents amplitude, and the horizontal axis represents time.

A haptic component 1402 may have a relatively lower frequency and a relatively higher amplitude compared to an audio component 1404. When applied to an actuator, the haptic component 1402 may produce tactile vibrations perceivable by a user through an input surface. The audio component 1404 may have a relatively higher frequency than the haptic component 1402 and may have a lower amplitude. When applied to the actuator, the audio component 1404 may produce audible vibrations.

While the haptic component 1402 and the audio component 1404 are illustrated as sinusoidal waveforms for clarity, other waveform shapes, envelopes, frequency profiles, or signal characteristics may be used. In some examples, the components may be dynamically generated, filtered, shaped, or otherwise modified.

FIG. 15 depicts an example signal graph 1500 including a composite drive signal 1502 generated from the signal components shown in FIG. 14. The composite drive signal 1502 may include both the haptic component 1402 and the audio component 1404.

In some examples, the composite drive signal 1502 is formed by superposition or direct addition of the haptic component 1402 and the audio component 1404. In such examples, the instantaneous amplitudes of the two components may be summed to form a single waveform that contains both low-frequency and high-frequency content.

In other examples, the composite drive signal 1502 is generated using modulation techniques. For example, the audio component 1404 may be amplitude-modulated by the haptic component 1402 such that the haptic component defines an amplitude envelope of the audio component. In other examples, the haptic component 1402 may be amplitude-modulated by the audio component 1404.

In still other examples, the composite drive signal 1502 may be generated using frequency-domain techniques, time-division techniques, pulse-width modulation, or combinations thereof. In some examples, the haptic component 1402 and the audio component 1404 occupy non-overlapping frequency ranges. In other examples, the frequency ranges may partially overlap.

When applied to an actuator, the composite drive signal 15023 may cause the actuator to produce both tactile and audible output simultaneously. This may allow a single actuator to function as both a haptic feedback device and an audio output device, reducing system complexity while enabling coordinated haptic and audio feedback.

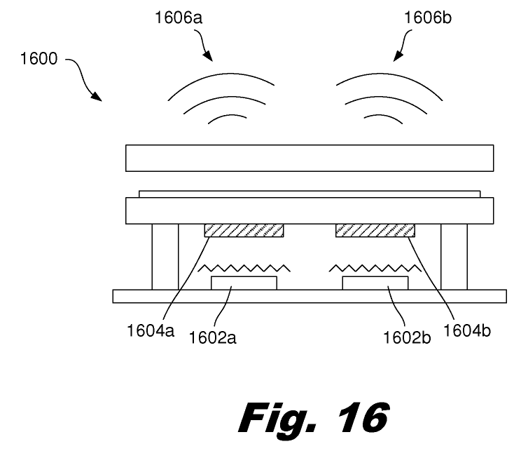

FIG. 16 depicts an example of a capacitance module 1600 which incorporates multiple coil actuators. In this example, the capacitance module 1600 includes a first inductive coil 1604a positioned interact with a first magnetic field source 1602a and a second inductive coil1 604b positioned to interact with a second magnetic field source 1602b. The first inductive coil 1604a and the second inductive coil 1604b may be disposed at different locations within the capacitance module 1600, such as at opposite sides or opposite ends of an input surface.

During operation, a first drive signal may be applied to the first inductive coil 1604a to generate a first mechanical vibration, which may produce a first audio output 1606a and/or a first haptic output. Similarly, a second drive signal may be applied to the second inductive coil 1604b to generate a second mechanical vibration, which may produce a second audio output 1606b and/or a second haptic output. In some examples, the first drive signal and the second drive signal are different from one another, allowing the capacitance module 1600 to produce stereo audio output in which the first audio output 1606a corresponds to a first audio channel and the second audio output 1606b corresponds to a second audio channel.

In some examples, the first inductive coil 1604a and the second inductive coil 1604b may also be driven to produce localized haptic feedback at different regions of the input surface. This may allow haptic effects to be spatially distributed or directional. In some cases, the inductive coils may be driven independently, while in other cases the inductive coils may be driven cooperatively to produce combined haptic or audio effects. Accordingly, FIG. 16 illustrates that multiple coil actuators may be incorporated into a single capacitance module to enable stereo audio output, spatially differentiated haptic feedback, or combinations thereof.

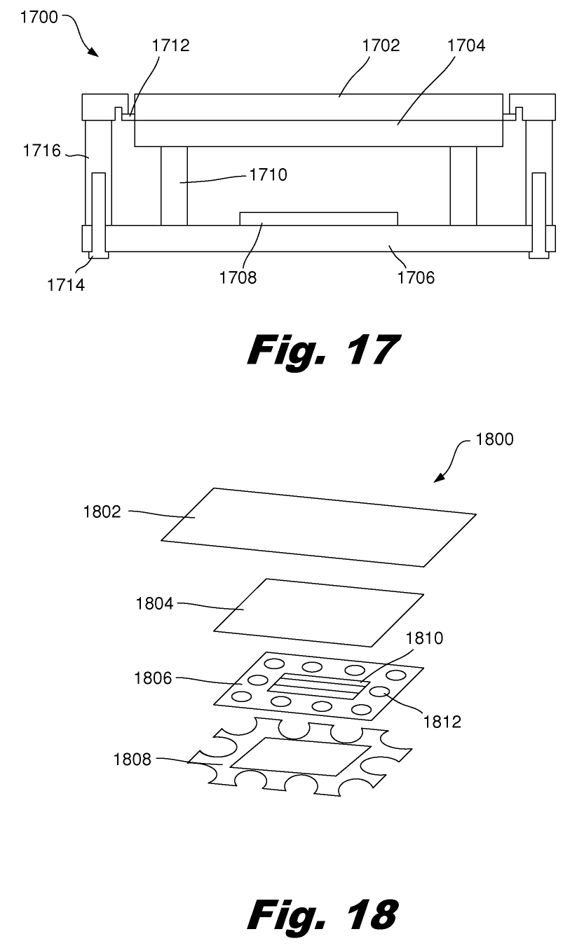

FIG. 17 depicts an example of a capacitance module 1700 in accordance with the disclosure. The capacitance module may include a capacitance reference surface 1702, a sensor layer 1704, and a baseplate 1706.

The capacitance reference surface 1702 may form an input surface through which capacitance measurements of the capacitance module 1700 are taken. As a user’s finger or another input object approaches or makes physical contact with the reference surface 1702, capacitance electrodes disposed on the sensor layer 1704 adjacent to the reference surface may measure changes in capacitance corresponding to the user input.

The baseplate 1706 may be attached to the reference surface 1702 through screw bores 1716 located on the side of the baseplate and connected to the reference surface via gaskets 1712. The screw bores 1716 may be attached to the baseplate 1706 by screws 1714 which transverse the material of the baseplate and extend into the screw bores 1716. In other embodiments, a baseplate may be attached to a reference surface by another mechanism. In some examples, the gaskets 1712 may rigidly attach the screw bores 1716 to the reference surface 1702, while in other examples, the connection may be at least partially flexible.

In some examples, the sensor layer 1704 may include an inductance coil positioned to interact with a magnetic field source 1708 disposed on the baseplate 1706, forming a coil actuator as previously described herein. The coil actuator may be configured to generate a haptic effect and/or an audio effect. The haptic effect and audio effect may be generated independently from one another. In some examples, the haptic effect and the audio effect may be generated concurrently.

The sensor layer 1704 may be attached to the baseplate 1706 by deflection spacers 1710. The deflection spacers 1710 may be made of a semi-flexible material. During actuation of the coil actuator, the deflection spacers 1710 may flex in order to accommodate the vibration.

FIG. 18 depicts an example of a capacitance module 1800 in accordance with the disclosure. In this example, the capacitance module 1800 includes a capacitance reference surface 1802, a sensor layer 1804, a baseplate 1806, and a mounting bracket 1808. The baseplate may include a magnetic field source 1810 positioned to interact with an inductance coil disposed on the sensor layer 1804. The inductance coil and the magnetic field source 1810 may collectively form a coil actuator, which may be used to generate haptic effects and audio effects as previously described herein. The baseplate 1806 may include pressure sensors 1812 disposed around the periphery of the baseplate.

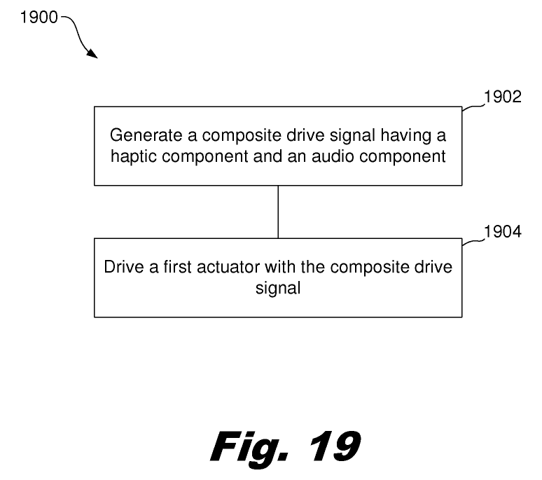

FIG. 19 depicts an example of a method 1900 of using a user input module. This method 1900 may be performed based on the description of the devices, modules, and principles described in relation to FIGS. 1-18. In this example, the method 1900 includes generating 1902 a composite drive signal having a haptic component and an audio component and 1904 driving a first actuator with the component drive signal.

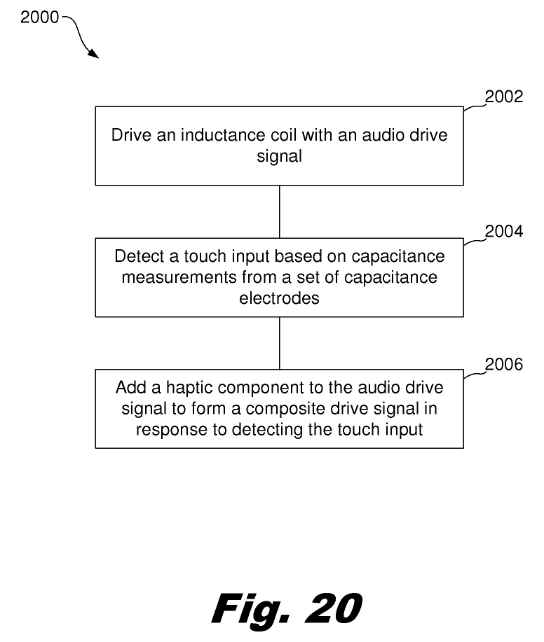

FIG. 20 depicts an example of a method 2000 of using a user input module. This method 2000 may be performed based on the description of the devices, modules, and principles described in relation to FIGS. 1-19. In this example, the method 2000 includes driving 2002 an inductance coil with an audio drive signal, detecting 2004 a touch input based on capacitance measurements from a set of capacitance electrodes, and adding 2006 a haptic component to the audio drive signal to form a composite drive signal in response to detecting the touch input.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations may be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

1. A capacitance module, comprising:
a stack of layers;
a set of capacitance electrodes disposed on a surface of the stack;
a first actuator, comprising:
an inductance coil disposed on at least one surface of the stack;
a magnetic field source positioned to at least partially overlap with the inductance coil;
a processor in communication with the set of capacitance electrodes and the first actuator;
memory in communication with the processor, the memory containing programmed instructions which cause the processor, when executed, to
generate a composite drive signal comprising a haptic component and an audio component; and
drive the first actuator with the composite drive signal;
wherein the haptic component has a lower center frequency than the audio component.

2. The capacitance module of claim 1, wherein the haptic component has a first frequency range, and the audio component has a second frequency range, wherein the first frequency range and second frequency range do not overlap.

3. The capacitance module of claim 2, wherein the first frequency range is below approximately 300 Hz, and the second frequency range is above approximately 1000 Hz.

4. The capacitance module of claim 1, wherein the haptic component and the audio component have frequency ranges which at least partially overlap.

5. The capacitance module of claim 1, wherein the programmed instructions further cause the processor, when executed, to
drive an audio drive signal with the inductance coil;
detect a touch input based on capacitance measurements from the set of capacitance electrodes;
add the haptic component to the audio drive signal to form the composite drive signal in response to detecting the touch input.

6. The capacitance module of claim 5, wherein the programmed instructions further cause the processor, when executed, to
reduce the audio component from the composite drive signal in response to detecting the touch input.

7. The capacitance module of claim 1, wherein the programmed instructions further cause the processor, when executed, to
detect a touch release based on capacitance measurements from the set of capacitance electrodes;
reapply the audio component to the composite drive signal in response to detecting the touch release.

8. The capacitance module of claim 7, wherein the programmed instructions further cause the processor, when executed, to
reduce the haptic component from the composite drive signal in response to detecting the touch release.

9. The capacitance module of claim 1, wherein the first actuator is configured to provide a substantially consistent mechanical response over a frequency range from approximately 5 Hz to approximately 20,000 Hz.

10. The capacitance module of claim 1, wherein the programmed instructions further cause the processor, when executed, to
receive an external audio signal;
generate at least one of the haptic component or the audio component based on the external audio signal such that the composite drive signal supplements the external audio signal.

11. The capacitance module of claim 10, wherein the haptic component is generated based on a low-frequency portion of the external audio signal.

12. The capacitance module of claim 1, wherein the composite drive signal is formed by superposition of the haptic component and the audio component.

13. The capacitance module of claim 1, wherein the composite drive signal is formed by either the haptic component amplitude modulated by the audio component or vice versa.

14. The capacitance module of claim 1, further comprising:
a second actuator disposed on an opposite side of the stack from the first actuator;
wherein the programmed instructions further cause the processor, when executed, to generate a stereo audio output by driving the first actuator with a first audio component and the second actuator with a second audio component different from the first audio component.

15. The capacitance module of claim 1, wherein the haptic component and the audio component are assigned relative priorities, and wherein an amplitude of at least one of the haptic component or the audio component is reduced based on the assigned priorities.

16. A computer-program product for driving a coil actuator of a capacitance module, the computer-program product comprising a non-transitory computer-readable medium storing instructions executable by a processor to
generate a composite drive signal comprising a haptic component and an audio component, and
drive the coil actuator with the composite drive signal;
wherein the haptic component has a lower center frequency than the audio component.

17. The computer-program product of claim 16, the medium storing further instructions executable by a processor to
drive an audio drive signal with the coil actuator;
detect a touch input based on capacitance measurements from a set of capacitance electrodes of the capacitance module;
add the haptic component to the audio drive signal to form the composite drive signal in response to detecting the touch input.

18. The computer-program product of claim 16, the medium storing further instructions executable by a processor to
detect a touch release based on capacitance measurements from a set of capacitance electrodes of the capacitance module;
reapply the audio component to the composite drive signal in response to detecting the touch release; and
reduce the haptic component from the composite drive signal in response to detecting the touch release.

19. The computer-program product of claim 16, the medium storing further instructions executable by a processor to
receive an external audio signal; and
generate at least one of the haptic component or the audio component based on the external audio signal such that the composite drive signal supplements the external audio signal.

20. The computer-program product of claim 16, the medium storing further instructions executable by a processor to
assign a first priority value to the audio component;
assign a second priority value to the haptic component;
wherein the relative amplitudes of the haptic component and the audio component are based, at least in part, on the first priority value and second priority value.
